(19) United States
(12) Patent Application Publication
(10) Pub. No.: US 2025/0083327 A1
(43) Pub. Date: Mar. 13, 2025

(54) IMAGING SYSTEM, IMAGING METHOD, AND STORAGE MEDIUM

(71) Applicant: CASIO COMPUTER CO., LTD., Tokyo (JP)

(72) Inventors: Toshiaki KANAMURA, Tokyo (JP); Erina ICHIKAWA, Tokyo (JP); Kayoko ONODA, Tokyo (JP); Wataru NIMURA, Tokyo (JP)

(73) Assignee: CASIO COMPUTER CO., LTD., Tokyo (JP)

(21) Appl. No.: 18/821,693

(22) Filed: Aug. 30, 2024

(30) Foreign Application Priority Data
Sep. 12, 2023 (JP) 2023-147301

(51) Int. Cl. B25J 9/16; B25J 19/02

(52) U.S. Cl. CPC B25J 9/1697; B25J 9/1661; B25J 19/023

(57) ABSTRACT

An imaging system includes a camera and at least one processor. The processor, in a case in which a gesture, that a robot is to be caused to execute at a time of video capturing, is selected from among a plurality of gestures registered in advance and, also, video capturing by the camera is to be started with the robot as a subject, controls the video capturing by the camera so that the video capturing ends at a timing corresponding to a timing at which the robot ends the gesture.

### CROSS-REFERENCE TO RELATED APPLICATIONS

This application is based upon and claims the benefit of priority under 35 USC 119 of Japanese Patent Application No. 2023-147301, filed on Sep. 12, 2023, the entire disclosure of which, including the description, claims, drawings, and abstract, is incorporated herein by reference in its entirety.

### FIELD OF THE INVENTION

This application relates generally to an imaging system, an imaging method, and a storage medium.

### BACKGROUND OF THE INVENTION

Electronic devices that imitate living creatures such as pets, human beings, and the like are known in the related art. For example, Unexamined Japanese Patent Application Publication No. 2003-225875 describes a pet-type robot that learns and grows while communicating with a user, and that is capable of autonomous action.

### SUMMARY OF THE INVENTION

An imaging system according to an embodiment of the present disclosure includes:
a camera; and
at least one processor;
wherein
the at least one processor
   in a case in which a gesture, that a robot is to be caused to execute at a time of video capturing, is selected from among a plurality of gestures registered in advance and, also, video capturing by the camera is to be started with the robot as a subject, controls the video capturing by the camera so that the video capturing ends at a timing corresponding to a timing at which the robot ends the gesture.

### BRIEF DESCRIPTION OF DRAWINGS

A more complete understanding of this application can be obtained when the following detailed description is considered in conjunction with the following drawings, in which:

FIG. 1 is a drawing illustrating a schematic of the entire configuration of a robot system according to Embodiment 1;

FIG. 2 is a cross-sectional view of a robot according to Embodiment 1, viewed from the side;

FIG. 3 is a drawing illustrating a housing of the robot according to Embodiment 1;

FIG. 4 is a first drawing illustrating a movement of a twist motor of the robot according to Embodiment 1;

FIG. 5 is a second drawing illustrating a movement of the twist motor of the robot according to Embodiment 1;

FIG. 6 is a first drawing illustrating a movement of a vertical motor of the robot according to Embodiment 1;

FIG. 7 is a second drawing illustrating a movement of the vertical motor of the robot according to Embodiment 1;

FIG. 8 is a block diagram illustrating the configuration of the robot according to Embodiment 1;

FIG. 9 is a block diagram illustrating the configuration of a terminal device according to Embodiment 1;

FIG. 10 is a drawing illustrating an example of an emotion map according to Embodiment 1;

FIG. 11 is a drawing illustrating an example of a personality value radar chart according to Embodiment 1;

FIG. 12 is a drawing illustrating an example of gesture information according to Embodiment 1;

FIG. 13 is a first drawing illustrating an example of a coefficient table according to Embodiment 1;

FIG. 14 is a second drawing illustrating an example of the coefficient table according to Embodiment 1;

FIG. 15 is a flowchart illustrating the flow of robot control processing according to Embodiment 1;

FIG. 16 is a flowchart illustrating the flow of gesture control processing according to Embodiment 1;

FIG. 17 is a drawing illustrating a display example of an imaging mode screen according to Embodiment 1;

FIG. 18 is a drawing illustrating a display example of a video playback screen according to Embodiment 1;

FIG. 19 is a sequence drawing illustrating the flow of video capturing processing according to Embodiment 1; and

FIG. 20 is a flowchart illustrating the flow of gesture selection processing by speech input according to Embodiment 1.

### DETAILED DESCRIPTION OF THE INVENTION

Hereinafter, embodiments of the present disclosure are described while referencing the drawings. Note that, in the drawings, identical or corresponding components are denoted with the same reference numerals.

### Embodiment 1

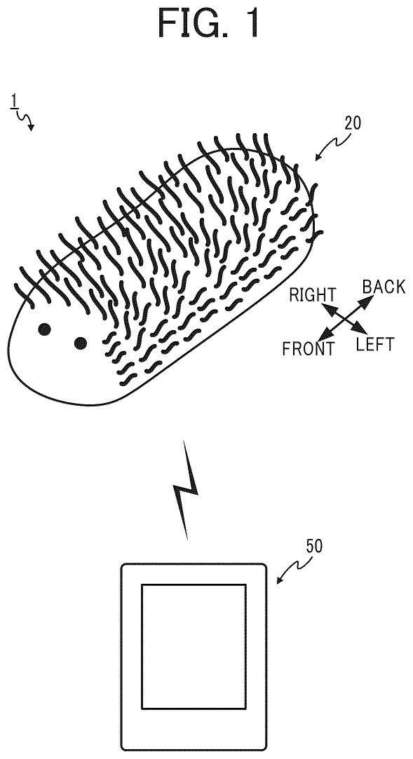

FIG. 1 schematically illustrates the configuration of a robot system 1 according to Embodiment 1. The robot system 1 includes a robot 20 and a terminal device 50. The robot 20 is an example of an electronic device according to Embodiment 1.

The robot 20 is a device that autonomously acts without direct operations by a user. The robot 20 is a pet robot that resembles a small animal. The robot 20 includes an exterior 201 provided with bushy fur and decorative parts resembling eyes.

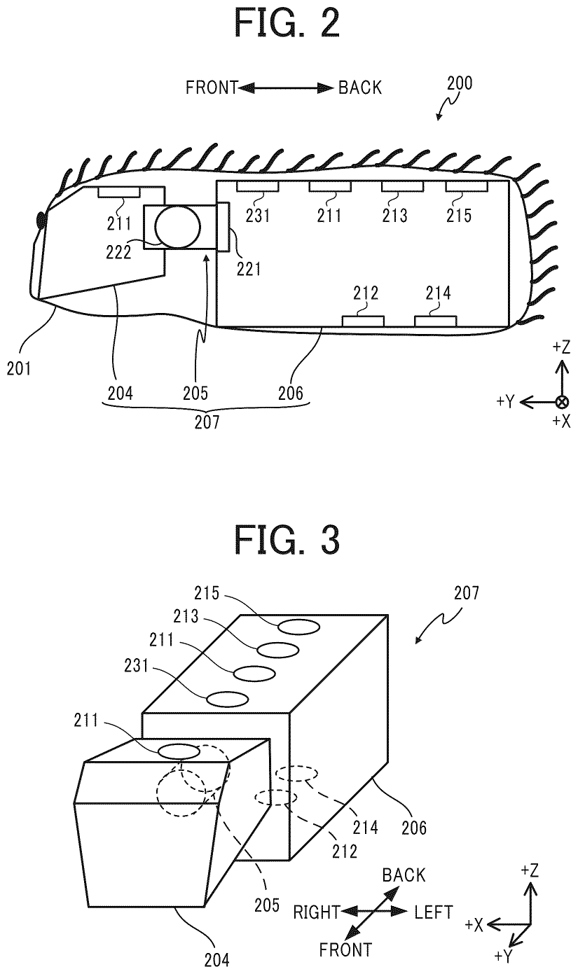

As illustrated in FIGS. 2 and 3, the robot 20 includes a housing 207. The housing 207 is covered by the exterior 201, and is accommodated inside the exterior 201. The housing 207 includes a head 204, a coupler 205, and a torso 206. The coupler 205 couples the head 204 to the torso 206.

The exterior 201 is an example of an exterior member, and has the shape of a bag that is long in a front-back direction and capable of accommodating the housing 207 therein. The exterior 201 is formed in a barrel shape from the head 204 to the torso 206, and integrally covers the torso 206 and the head 204. Due to the exterior 201 having such a shape, the robot 20 is formed in a shape as if lying on its belly.

An outer material of the exterior 201 simulates the feel to touch of a small animal, and is formed from an artificial pile fabric that resembles the fur of a small animal. A lining of the exterior 201 is formed from synthetic fibers, natural fibers, natural leather, artificial leather, a synthetic resin sheet material, a rubber sheet material, or the like. The exterior 201 is formed from such a flexible material and, as such, conforms to the movement of the housing 207. Specifically, the exterior 201 conforms to the rotation of the head 204 relative to the torso 206.

In order to configure so that the exterior 201 conforms to the movement of the housing 207, the exterior 201 is attached to the housing 207 by non-illustrated snap buttons. Specifically, at least one snap button is provided at the front of the head 204, and at least one snap button is provided at the rear of the torso 206. Moreover, snap buttons, that engage with the snap buttons provided on the head 204 and the torso 206, are also provided at corresponding positions of the exterior 201, and the exterior 201 is fixed to the housing 207 by the snap buttons. Note that the numbers and positions of the snap buttons are merely examples, and can be changed as desired.

The torso 206 extends in the front-back direction, and contacts, via the exterior 201, a placement surface such as a floor, a table, or the like on which the robot 20 is placed. The torso 206 includes a twist motor 221 at a front end thereof. The head 204 is coupled to the front end of the torso 206 via the coupler 205. The coupler 205 includes a vertical motor 222. Note that, in FIG. 2, the twist motor 221 is provided on the torso 206, but may be provided on the coupler 205. Due to the twist motor 221 and the vertical motor 222, the head 204 is coupled to the torso 206 so as to be rotatable, around a left-right direction and the front-back direction of the robot 20, with respect to the torso 206.

Note that, as XYZ coordinate axes, an X axis and a Y axis are set in the horizontal plane, and a Z axis is set in the vertical direction. The + direction of the Z axis corresponds to vertically upward. Moreover, to facilitate comprehension, in the following, a description is given in which the robot 20 is placed on the placement surface and oriented such that the left-right direction (the width direction) of the robot 20 is the X axis direction and the front-back direction of the robot 20 is the Y axis direction.

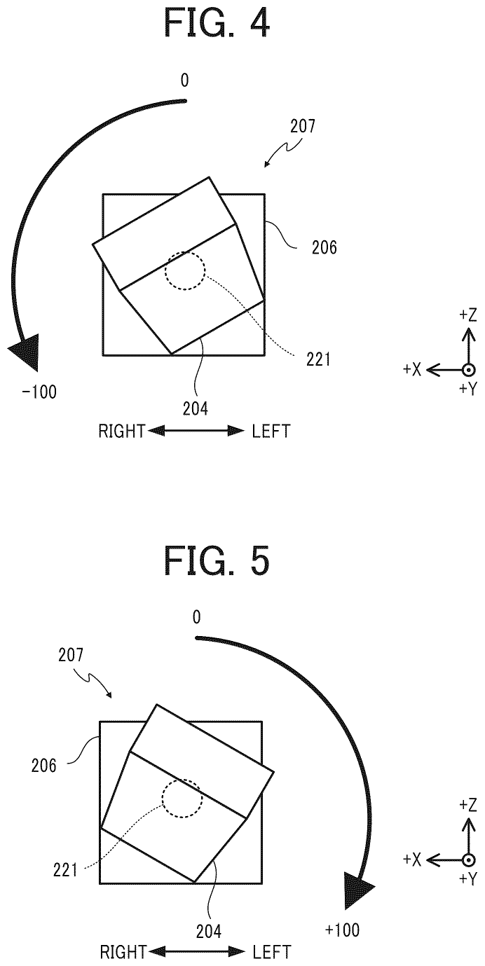

The coupler 205 couples the torso 206 and the head 204 so as to enable rotation around a first rotational axis that passes through the coupler 205 and extends in the front-back direction (the Y axis direction) of the torso 206. As illustrated in FIGS. 4 and 5, the twist motor 221 rotates the head 204, with respect to the torso 206, clockwise (right rotation) within a forward rotation angle range around the first rotational axis (forward rotation), counter-clockwise (left rotation) within a reverse rotation angle range around the first rotational axis (reverse rotation), and the like.

Note that, in this description, the term “clockwise” refers to clockwise when viewing the direction of the head 204 from the torso 206. Additionally, herein, clockwise rotation is also referred to as “twist rotation to the right”, and counter-clockwise rotation is also referred to as “twist rotation to the left.” A maximum value of an angle of twist rotation to the right or the left can be set as desired. In FIGS. 4 and 5, the angle of the head 204 in a state in which the head 204 is not twisted to the right or the left (hereinafter, “twist reference angle”) is expressed by 0. An angle when twist rotated most to the left (rotated counter-clockwise) is expressed as −100, and an angle when twist rotated most to the right (rotated clockwise) is expressed as +100.

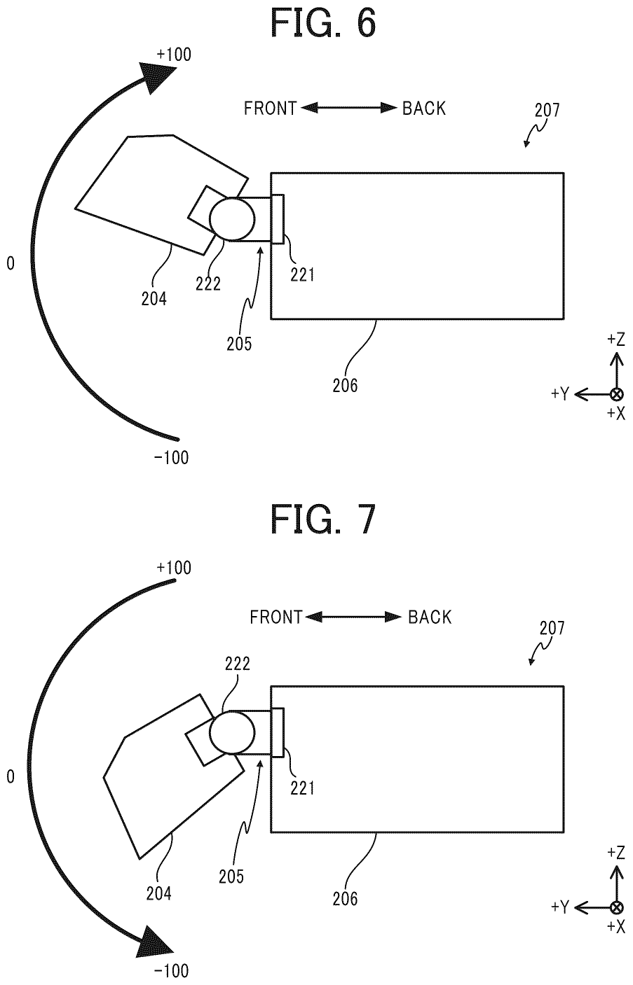

Additionally, the coupler 205 couples the torso 206 and the head 204 so as to enable rotation around a second rotational axis that passes through the coupler 205 and extends in the left-right direction (the width direction, the X axis direction) of the torso 206. As illustrated in FIGS. 6 and 7, the vertical motor 222 rotates the head 204 upward (forward rotation) within a forward rotation angle range around the second rotational axis, downward (reverse rotation) within a reverse rotation angle range around the second rotational axis, and the like.

A maximum value of the angle of rotation upward or downward can be set as desired, and, in FIGS. 6 and 7, the angle of the head 204 in a state in which the head 204 is not rotated upward or downward (hereinafter, “vertical reference angle”) is expressed by 0, an angle when rotated most downward is expressed as −100, and an angle when rotated most upward is expressed as +100.

As illustrated in FIGS. 2 and 3, the robot 20 includes a touch sensor 211 on the head 204 and the torso 206. The robot 20 can detect, by the touch sensor 211, petting or striking of the head 204 or the torso 206 by the user.

The robot 20 includes, on the torso 206, an acceleration sensor 212, a microphone 213, a gyrosensor 214, an illuminance sensor 215, and a speaker 231. By using the acceleration sensor 212 and the gyrosensor 214, the robot 20 can detect a change of an attitude of the robot 20 itself, and can detect being picked up, the orientation being changed, being thrown, and the like by the user. The robot 20 can detect the ambient illuminance of the robot 20 by using the illuminance sensor 215. The robot 20 can detect external sounds by using the microphone 213. The robot 20 can emit sounds by using the speaker 231.

Note that, at least a portion of the acceleration sensor 212, the microphone 213, the gyrosensor 214, the illuminance sensor 215, and the speaker 231 is not limited to being provided on the torso 206 and may be provided on the head 204, or may be provided on both the torso 206 and the head 204.

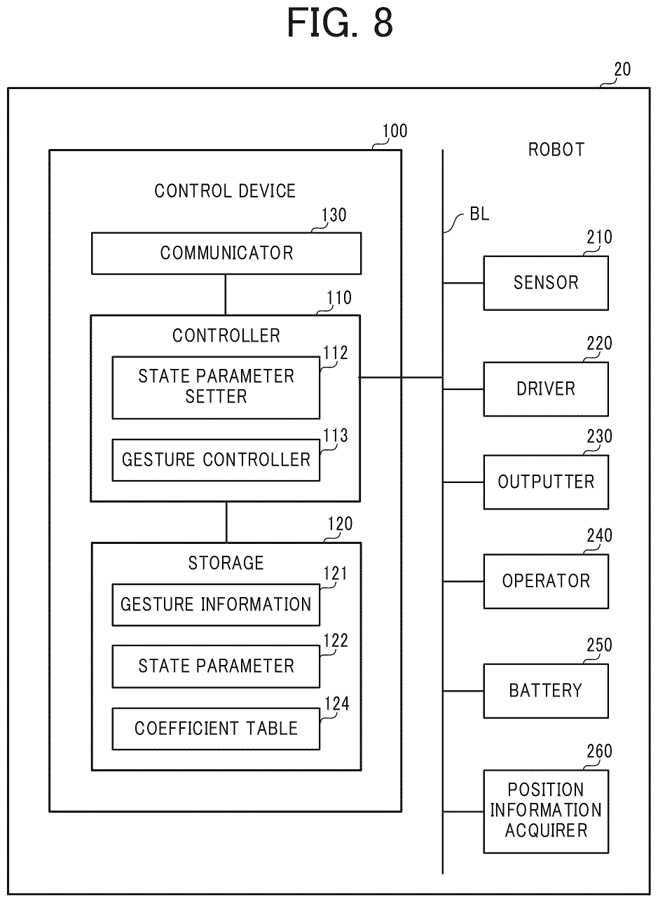

Next, the functional configuration of the robot 20 is described while referencing FIG. 8. As illustrated in FIG. 8, the robot 20 includes a control device 100, a sensor 210, a driver 220, an outputter 230, and an operator 240. In one example, these various components are connected via a bus line BL. Note that a configuration is possible in which, instead of the bus line BL, a wired interface such as a universal serial bus (USB) cable or the like, or a wireless interface such as Bluetooth (registered trademark) or the like is used.

The control device 100 is a device that controls the robot 20. The control device 100 includes a controller 110 that is an example of control means, a storage 120 that is an example of storage means, and a communicator 130 that is an example of communication means.

The controller 110 includes a central processing unit (CPU). In one example, the CPU is a microprocessor or the like and is a central processing unit that executes a variety of processing and computations. In the controller 110, the CPU reads out a control program stored in the ROM and controls the behavior of the entire robot 20 while using the RAM as working memory. Additionally, while not illustrated in the drawings, the controller 110 is provided with a clock function, a timer function, and the like, and can measure the date and time, and the like. The controller 110 may also be called a “processor.”

The storage 120 includes read-only memory (ROM), random access memory (RAM), flash memory, and the like. The storage 120 stores an operating system (OS), application programs, and other programs and data used by the controller 110 to perform the various processes. Moreover, the storage unit 120 stores data generated or acquired as a result of the controller 110 performing the various processes.

The communicator 130 includes an interface for communicating with external devices of the robot 20. In one example, the communicator 130 communicates with external devices including the terminal device 50 in accordance with a known communication standard such as a wireless local area network (LAN), Bluetooth Low Energy (BLE, registered trademark), Near Field Communication (NFC), or the like.

The sensor 210 includes the touch sensor 211, the acceleration sensor 212, the gyrosensor 214, the illuminance sensor 215, and the microphone 213 described above. The sensor 210 is an example of detection means that detects an external stimulus.

The touch sensor 211 includes, for example, a pressure sensor and a capacitance sensor, and detects contacting by some sort of object. The controller 110 can, on the basis of detection values of the touch sensor 211, detect that the robot 20 is being pet, is being struck, and the like by the user.

The acceleration sensor 212 detects an acceleration applied to the torso 206 of the robot 20. The acceleration sensor 212 detects acceleration in each of the X axis direction, the Y axis direction, and the Z axis direction. That is, the acceleration sensor 212 detects acceleration on three axes.

In one example, the acceleration sensor 212 detects gravitational acceleration when the robot 20 is stationary. The controller 110 can detect the current attitude of the robot 20 on the basis of the gravitational acceleration detected by the acceleration sensor 212. In other words, the controller 110 can detect whether the housing 207 of the robot 20 is inclined from the horizontal direction on the basis of the gravitational acceleration detected by the acceleration sensor 212. Thus, the acceleration sensor 212 functions as an incline detection means that detects the inclination of the robot 20.

Additionally, when the user picks up or throws the robot 20, the acceleration sensor 212 detects, in addition to the gravitational acceleration, acceleration caused by the movement of the robot 20. Accordingly, the controller 110 can detect the movement of the robot 20 by removing the gravitational acceleration component from the detection value detected by the acceleration sensor 212.

The gyrosensor 214 detects an angular velocity from when rotation is applied to the torso 206 of the robot 20. Specifically, the gyrosensor 214 detects the angular velocity on three axes of rotation, namely rotation around the X axis direction, rotation around the Y axis direction, and rotation around the Z axis direction. It is possible to more accurately detect the movement of the robot 20 by combining the detection value detected by the acceleration sensor 212 and the detection value detected by the gyrosensor 214.

Note that, at a synchronized timing (for example every 0.25 seconds), the touch sensor 211, the acceleration sensor 212, and the gyrosensor 214 respectively detect the strength of contact, the acceleration, and the angular velocity, and output the detection values to the controller 110.

The microphone 213 detects ambient sound of the robot 20. The controller 110 can, for example, detect, on the basis of a component of the sound detected by the microphone 213, that the user is speaking to the robot 20, that the user is clapping their hands, and the like.

The illuminance sensor 215 detects the illuminance of the surroundings of the robot 20. The controller 110 can detect that the surroundings of the robot 20 have become brighter or darker on the basis of the illuminance detected by the illuminance sensor 215.

The controller 110 acquires, via the bus line BL and as an external stimulus, detection values detected by the various sensors of the sensor 210. The external stimulus is a stimulus that acts on the robot 20 from outside the robot 20. Examples of the external stimulus include “there is a loud sound”, “spoken to”, “petted”, “picked up”, “turned upside down”, “became brighter”, “became darker”, and the like.

In one example, the controller 110 acquires the external stimulus of “there is a loud sound” or “spoken to” by the microphone 213, and acquires the external stimulus of “petted” by the touch sensor 211. Additionally controller 110 acquires the external stimulus of “picked up” or “turned upside down” by the acceleration sensor 212 and the gyrosensor 214, and acquires the external stimulus of “became brighter” or “became darker” by the illuminance sensor 215.

Note that a configuration is possible in which the sensor 210 includes sensors other than the touch sensor 211, the acceleration sensor 212, the gyrosensor 214, and the microphone 213. The types of external stimuli acquirable by the controller 110 can be increased by increasing the types of sensors of the sensor 210.

The driver 220 includes the twist motor 221 and the vertical motor 222, and is driven by the controller 110. The twist motor 221 is a servo motor for rotating the head 204, with respect to the torso 206, in the left-right direction (the width direction) with the front-back direction as an axis. The vertical motor 222 is a servo motor for rotating the head 204, with respect to the torso 206, in the up-down direction (height direction) with the left-right direction as an axis. The robot 20 can express actions of turning the head 204 to the side by using the twist motor 221, and can express actions of lifting/lowering the head 204 by using the vertical motor 222.

The outputter 230 includes the speaker 231, and sound is output from the speaker 231 as a result of sound data being input into the outputter 230 by the controller 110. For example, the robot 20 emits a pseudo-animal sound as a result of the controller 110 inputting animal sound data of the robot 20 into the outputter 230.

A configuration is possible in which, instead of the speaker 231, or in addition to the speaker 231, a display such as a liquid crystal display, a light emitter such as a light emitting diode (LED), or the like is provided as the outputter 230, and emotions such as joy, sadness, and the like are displayed on the display, expressed by the color and brightness of the emitted light, or the like.

The operator 240 includes an operation button, a volume knob, or the like. In one example, the operator 240 is an interface for receiving user operations such as turning the power ON/OFF, adjusting the volume of the output sound, and the like.

A battery 250 is a rechargeable secondary battery, and stores power to be used in the robot 20. The battery 250 is charged when the robot 20 has moved to a charging station.

A position information acquirer 260 includes a position information sensor that uses a global positioning system (GPS), and acquires current position information of the robot 20. Note that the position information acquirer 260 is not limited to GPS, and a configuration is possible in which the position information acquirer 260 acquires the position information of the robot 20 by a common method that uses wireless communication, or acquires the position information of the robot 20 through an application/software of the terminal device 50.

The controller 110 functionally includes a state parameter acquirer 112 that is an example of a state parameter acquisition means, and a gesture controller 113 that is an example of a gesture control means. In the controller 110, the CPU performs control and reads the program stored in the ROM out to the RAM and executes that program, thereby functioning as the various components described above.

Additionally, the storage 120 stores gesture information 121, a state parameter 122, and a coefficient table 124.

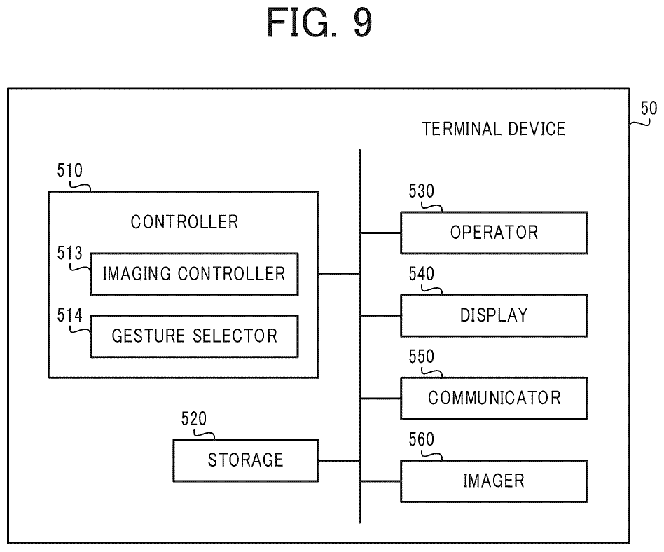

Next, the configuration of the terminal device 50 is described while referencing FIG. 9. The terminal device 50 is an operation terminal that is operated by the user. In one example, the terminal device 50 is a general purpose information processing device such a smartphone, a tablet terminal, a wearable terminal, or the like. As illustrated in FIG. 9, the terminal device 50 includes a controller 510, a storage 520, an operator 530, a display 540, a communicator 550, and an imager 560.

The controller 510 includes a CPU. In the controller 110, the CPU reads a control program stored in the ROM and controls the operations of the entire terminal device 50 while using the RAM as working memory. The controller 510 may also be called a “processor.”

The storage 520 includes a ROM, a RAM, a flash memory, and the like. The storage 520 stores programs and data used by the controller 510 to perform various processes. Moreover, the storage 520 stores data generated or acquired as a result of the controller 510 performing the various processes.

The operator 530 includes an input device such as a touch panel, a touch pad, a physical button, and the like, and receives operation inputs from the user.

The display 540 includes a display device such as a liquid crystal display or the like, and displays various images on the basis of control by the controller 510. The display 540 is an example of display means.

The communicator 550 includes a communication interface for communicating with external devices of the terminal device 50. In one example, the communicator 550 communicates with external devices including the robot 20 in accordance with a known communication standard such as a wireless LAN, BLE (registered trademark), NFC, or the like.

The imager 560 is a so-called camera, and images a subject including the robot 20 to acquire a captured image of the subject. Specifically, the imager 560 includes a lens that focuses light emitted from the subject, an imaging element such as a charge coupled device (CCD), a complementary metal oxide semiconductor (CMOS), or the like, and an analog/digital (A/D) converter that converts, to digital data, data representing an image sent as an electronic signal from the imaging element. The captured image captured by the imager 560 may be a still image, or may be a moving image. The imager 560 is an example of imaging means.

The controller 510 functionally includes an imaging controller 513 that is an example of an imaging control means, and a gesture selector 514 that is an example of a gesture selection means. In the controller 510, the CPU performs control and reads the program stored in the ROM out to the RAM and executes that program, thereby functioning as the various components described above. Additionally, the storage 520 stores the gesture information 121.

Returning to FIG. 8, in the control device 100 of the robot 20, the state parameter acquirer 112 acquires the state parameter 122. The state parameter 122 is a parameter for expressing the state of the robot 20. Specifically, the state parameter 122 includes: (1) an emotion parameter, (2) a personality parameter, (3) a battery level, (4) a current location, (5) a current time, and (6) a growth days count (development days count).

### (1) Emotion Parameter

The emotion parameter is a parameter that represents a pseudo-emotion of the robot 20. The emotion parameter is expressed by coordinates (X, Y) on an emotion map 300.

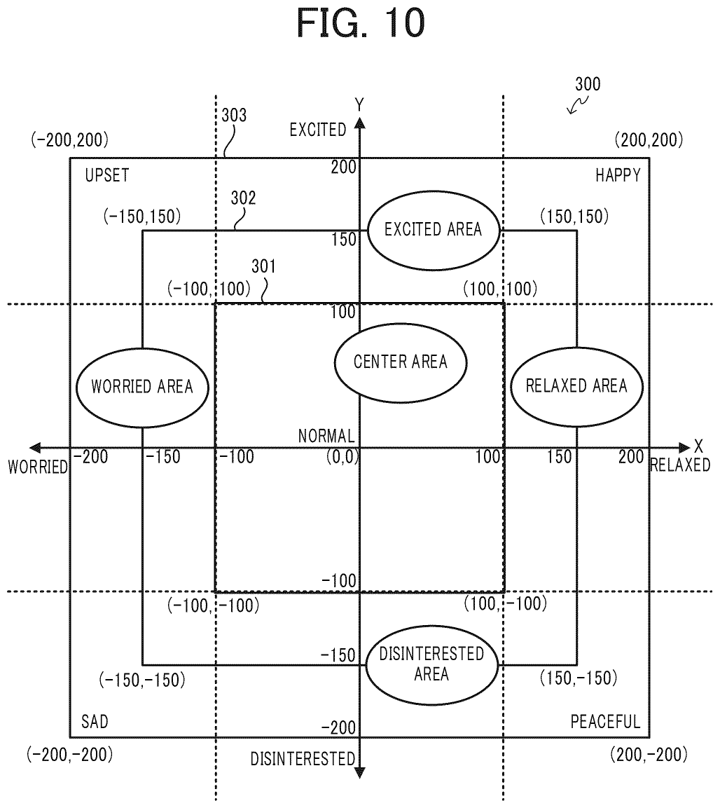

As illustrated in FIG. 10, the emotion map 300 is expressed by a two-dimensional coordinate system with a degree of relaxation (degree of worry) axis as an X axis, and a degree of excitement (degree of disinterest) axis as a Y axis. An origin (0, 0) on the emotion map 300 represents an emotion when normal. As the value of the X coordinate (X value) is positive and the absolute value thereof increases, emotions for which the degree of relaxation is high are expressed and, as the value of the X coordinate (X value) is negative and the absolute value thereof increases, emotions for which the degree of worry is high are expressed. As the value of the Y coordinate (Y value) is positive and the absolute value thereof increases, emotions for which the degree of excitement is high are expressed and, as the value of the Y coordinate (Y value) is negative and the absolute value thereof increases, emotions for which the degree of disinterest is high are expressed.

The emotion parameter represents a plurality (in the present embodiment, four) of mutually different pseudo-emotions. In FIG. 10, of the values representing pseudo-emotions, the degree of relaxation and the degree of worry are represented together on one axis (X axis), and the degree of excitement and the degree of disinterest are represented together on another axis (Y axis). Accordingly, the emotion parameter has two values, namely the X value (degree of relaxation, degree of worry) and the Y value (degree of excitement, degree of disinterest), and points on the emotion map 300 represented by the X value and the Y value represent the pseudo-emotions of the robot 20. An initial value of the emotion parameter is (0, 0). Note that the emotion map 300 is expressed by a two-dimensional coordinate system in FIG. 10, but the emotion map 300 may also be, for example, one-dimensional or three-dimensional.

The state parameter acquirer 112 calculates an emotion change amount that is an amount of change that each of the X value and the Y value of the emotion parameter is increased or decreased. The emotion change amount is expressed by the following four variables.
DXP: Tendency to relax (tendency to change in the positive value direction of the X value on the emotion map)
DXM: Tendency to worry (tendency to change in the negative value direction of the X value on the emotion map)
DYP: Tendency to be excited (tendency to change in the positive value direction of the Y value on the emotion map)
DYM: Tendency to be disinterested (tendency to change in the negative value direction of the Y value on the emotion map)

The state parameter acquirer 112 updates the emotion parameter by adding or subtracting a value, among the emotion change amounts DXP, DXM, DYP, and DYM, corresponding to the external stimulus to or from the current emotion parameter. For example, when the head 204 is petted, the pseudo-emotion of the robot 20 is relaxed and, as such, the state parameter acquirer 112 adds the DXP to the X value of the emotion parameter. Conversely, when the head 204 is struck, the pseudo-emotion of the robot 20 is worried and, as such, the state parameter acquirer 112 subtracts the DXM from the X value of the emotion parameter. Which emotion change amount is associated with the various external stimuli can be set as desired. An example is given below.
The head 204 is petted (relax): X=X+DXP
The head 204 is struck (worry): X=X−DXM
   (these external stimuli can be detected by the touch sensor 211 of the head 204)
The torso 206 is petted (excite): Y=Y+DYP
The torso 206 is struck (disinterest): Y=Y−DYM
   (these external stimuli can be detected by the touch sensor 211 of the torso 206)
Held with head upward (happy): X=X+DXP and Y=Y+DYP
Suspended with head downward (sad): X=X−DXM and Y=Y−DYM
   (these external stimuli can be detected by the touch sensor 211 and the acceleration sensor 212)
Spoken to in kind voice (peaceful): X=X+DXP and Y=Y−DYM
Yelled at in loud voice (upset): X=X−DXM and Y=Y+DYP
   (these external stimuli can be detected by the microphone 213)

The sensor 210 acquires a plurality of external stimuli of different types by a plurality of sensors. The state parameter acquirer 112 derives various emotion change amounts in accordance with each individual external stimulus of the plurality of external stimuli, and sets the emotion parameter in accordance with the derived emotion change amounts.

The initial value of these emotion change amounts DXP, DXM, DYP, and DYM is 10, and the amounts increase to a maximum of 20. The state parameter acquirer 112 updates the various variables, namely the emotion change amounts DXP, DXM, DYP, and DYM in accordance with the external stimuli detected by the sensor 210. Specifically, when the X value of the emotion parameter is set to the maximum value of the emotion map 300 even once in one day, the state parameter acquirer 112 adds 1 to the DXP, and when the Y value of the emotion parameter is set to the maximum value of the emotion map 300 even once in one day, the state parameter acquirer 112 adds 1 to the DYP. Additionally, when the X value of the emotion parameter is set to the minimum value of the emotion map 300 even once in one day, the state parameter acquirer 112 adds 1 to the DXM, and when the Y value of the emotion parameter is set to the minimum value of the emotion map 300 even once in one day, the state parameter acquirer 112 adds 1 to the DYM.

Thus, the state parameter acquirer 112 changes the emotion change amounts in accordance with a condition based on whether the value of the emotion parameter reaches the maximum value or the minimum value of the emotion map 300. Due to this updating processing, each emotion change amount, that is, the degree of change of emotion, changes. For example, when only the head 204 is petted multiple times, only the emotion change amount DXP increases and the other emotion change amounts do not change. As such, the robot 20 develops a personality of having a tendency to be relaxed. When only the head 204 is struck multiple times, only emotion change amount DXM increases and the other emotion change amounts do not change. As such the robot 20 develops a personality of having a tendency to be worried. Thus, the state parameter acquirer 112 changes the emotion change amounts in accordance with various external stimuli.

### (2) Personality Parameter

The personality parameter is a parameter expressing the pseudo-personality of the robot 20. The personality parameter includes a plurality of personality values that express degrees of mutually different personalities. The state parameter acquirer 112 changes the plurality of personality values included in the personality parameter in accordance with external stimuli detected by the sensor 210.

Specifically, the state parameter acquirer 112 calculates four personality values on the basis of (Equation 1) below. Specifically, a value obtained by subtracting 10 from DXP that expresses a tendency to be relaxed is set as a personality value (chipper), a value obtained by subtracting 10 from DXM that expresses a tendency to be worried is set as a personality value (shy), a value obtained by subtracting 10 from DYP that expresses a tendency to be excited is set as a personality value (active), and a value obtained by subtracting 10 from DYM that expresses a tendency to be disinterested is set as a personality value (spoiled).

$$Personality value ( chipper ) = DXP - 10 Personality value ( shy ) = DXM - 10 Personality value ( active ) = DYP - 10 Personality value ( spoiled ) = DYM - 10 \qquad ( Equation 1 )$$

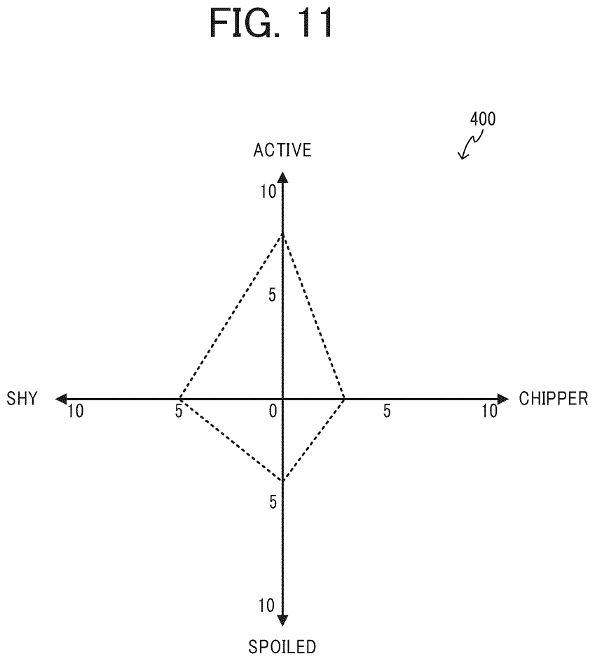

As a result, as illustrated in FIG. 11, it is possible to generate a personality value radar chart 400 by plotting each of the personality value (chipper) on a first axis, the personality value (active) on a second axis, the personality value (shy) on a third axis, and the personality value (spoiled) on fourth axis. Since the various emotion change amount variables each have an initial value of 10 and increase up to 20, the range of the personality value is from 0 to 10.

Since the initial value of each of the personality values is 0, the personality at the time of birth of the robot 20 is expressed by the origin of the personality value radar chart 400. Moreover, as the robot 20 grows, the four personality values change, with an upper limit of 10, due to external stimuli and the like (manner in which the user interacts with the robot 20) detected by the sensor 210. Therefore, 11 to the power of 4=14,641 types of personalities can be expressed. Thus, the robot 20 assumes various personalities in accordance with the manner in which the user interacts with the robot 20. That is, the personality of each individual robot 20 is formed differently on the basis of the manner in which the user interacts with the robot 20.

These four personality values are fixed when the juvenile period elapses and the pseudo-growth of the robot 20 is complete. In the subsequent adult period, the state parameter acquirer 112 adjusts four personality correction values (chipper correction value, active correction value, shy correction value, and spoiled correction value) in order to correct the personality in accordance with the manner in which the user interacts with the robot 20.

The state parameter acquirer 112 adjusts the four personality correction values in accordance with a condition based on where the area in which the emotion parameter has existed the longest is located on the emotion map 300. Specifically, the four personality correction values are adjusted as in (A) to (E) below.
(A) When the longest existing area is the relaxed area on the emotion map 300, the state parameter acquirer 112 adds 1 to the chipper correction value and subtracts 1 from the shy correction value.
(B) When the longest existing area is the excited area on the emotion map 300, the state parameter acquirer 112 adds 1 to the active correction value and subtracts 1 from the spoiled correction value.
(C) When the longest existing area is the worried area on the emotion map 300, the state parameter acquirer 112 adds 1 to the shy correction value and subtracts 1 from the chipper correction value.
(D) When the longest existing area is the disinterested area on the emotion map 300, the state parameter acquirer 112 adds 1 to the spoiled correction value and subtracts 1 from the active correction value.
(E) When the longest existing area is the center area on the emotion map 300, the state parameter acquirer 112 reduces the absolute value of all four of the personality correction values by 1.

When setting the four personality correction values, the state parameter acquirer 112 calculates the four personality values in accordance with (Equation 2) below.

$$Personality value ( chipper ) = DXP - 10 + chipper correction value Personality value ( shy ) = DXM - 10 + shy correction value Personality value ( active ) = DYP - 10 + active correction value Personality value ( spoiled ) = DYM - 10 + spoiled correction value \qquad ( Equation 2 )$$

### (3) Battery Level

The battery level is the remaining amount of power stored in the battery 250, and is a parameter expressing a pseudo degree of hunger of the robot 20. The state parameter acquirer 112 acquires information about the current battery level by a power supply controller that controls charging and discharging of the battery 250.

### (4) Current Location

The current location is the location at which the robot 20 is currently positioned. The state parameter acquirer 112 acquires information about the current position of the robot 20 by the position information acquirer 260.

More specifically, the state parameter acquirer 112 references past position information of the robot 20.

The state parameter acquirer 112 determines that the current location is home when the current location matches a position where the record frequency is the highest. When the current location is not the home, the state parameter acquirer 112 determines, on the basis of the past record count of that location, whether the current location is a location visited for the first time, a frequently visited location, a location not frequently visited, or the like, and acquires determination information thereof. For example, when the past record count is five times or greater, the state parameter acquirer 112 determines that the current location is a frequently visited location, and when the past record count is less than five times, the state parameter acquirer 112 determines that the current location is a location not frequently visited.

### (5) Current Time

The current time is the time at present. The state parameter acquirer 112 acquires the current time by a clock provided to the robot 20. Note that, as with the acquisition of the position information, the acquisition of the current time is not limited to this method. More specifically, the state parameter acquirer 112 references a pseudo-sleep ON/OFF log of the robot 20 to determine whether the current time corresponds to immediately after a wake-up time, immediately before a bed time, or a nap time of the current day.

### (6) Growth Days Count (Development Days Count)

The growth days count expresses the number of days of pseudo-growth of the robot 20. The robot 20 is pseudo-born at the time of first start up by the user after shipping from the factory, and grows from a juvenile to an adult over a predetermined growth period. The growth days count corresponds to the number of days since the pseudo-birth of the robot 20.

An initial value of the growth days count is 1, and the state parameter acquirer 112 adds 1 to the growth days count for each passing day. In one example, the growth period in which the robot 20 grows from a juvenile to an adult is 50 days, and the 50-day period that is the growth days count since the pseudo-birth is referred to as a “juvenile period (first period).” When the juvenile period elapses, the pseudo-growth of the robot 20 ends. A period after the completion of the juvenile period is called an “adult period (second period).”

During the juvenile period, each time the pseudo growth days count of the robot 20 increases one day, the state parameter acquirer 112 increases the maximum value and the minimum value of the emotion map 300 both by two. Regarding an initial value of the size of the emotion map 300, as illustrated by a frame 301, a maximum value of both the X value and the Y value is 100 and a minimum value is −100. When the growth days count exceeds half of the juvenile period (for example, 25 days), as illustrated by a frame 302, the maximum value of the X value and the Y value is 150 and the minimum value is −150. When the juvenile period elapses, the pseudo-growth of the robot 20 ends. At this time, as illustrated by a frame 303, the maximum value of the X value and the Y value is 200 and the minimum value is −200. Thereafter, the size of the emotion map 300 is fixed.

A settable range of the emotion parameter is defined by the emotion map 300. Thus, as the size of the emotion map 300 expands, the settable range of the emotion parameter expands Due to the settable range of the emotion parameter expanding, richer emotion expression becomes possible and, as such, the pseudo-growth of the robot 20 is expressed by the expanding of the size of the emotion map 300.

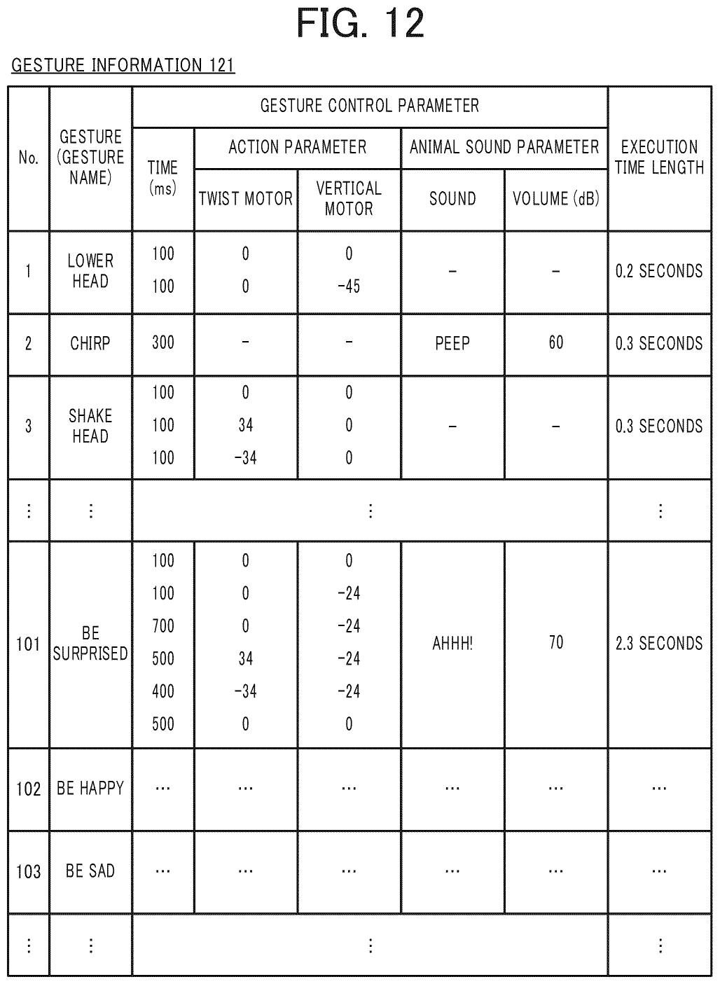

Returning to FIG. 8, the gesture controller 113 causes the robot 20 to execute various gestures corresponding to the situation, on the basis of the gesture information 121. The gesture information 121 is information that defines gestures to be executed by the robot 20. Here, the term “gesture” refers to a behavior, action, or the like of the robot 20. Specifically, as illustrated in FIG. 12, the term “gesture” includes “lower head”, “chirp”, “shake head”, “be surprised”, “be happy”, “be sad”, and the like. Examples of gestures other than those illustrated in FIG. 12 include various gestures such as “laugh”, “get angry”, “sneeze”, “breathe”, and the like. Each gesture includes a combination of a plurality of elements, namely actions and/or sound outputs.

The “action” refers to a physical motion of the robot 20, executed by driving of the driver 220. Specifically, the “action” corresponds to moving the head 204 relative to the torso 206 by the twist motor 221 or the vertical motor 222. The “sound output” refers to outputting of various sounds such as animal sounds or the like from the speaker 231 of the outputter 230.

As illustrated in FIG. 12, the gesture information 121 defines gesture control parameters for each of the plurality of gestures executable by the robot 20. The gesture control parameters are parameters for causing the robot 20 to execute each gesture. The gesture control parameters define, for every element of a gesture, an action parameter or an animal sound parameter, and an amount of time (ms) for executing that element. The action parameter defines an action angle of the twist motor 221 and an action angle of the vertical motor 222. The animal sound parameter defines a sound and a volume.

As an example, when the robot 20 is caused to execute the gesture “lower head”, firstly, after 100 ms, the gesture controller 113 controls the twist motor 221 and the vertical motor 222 so that the angles are 0 degrees and, then, after 100 ms, controls so that the angle of the vertical motor 222 is −45 degrees. When the robot 20 is caused to execute the gesture “chirp”, the gesture controller 113 outputs, from the speaker 231, a sound “peep” for 300 ms at a volume of 60 dB. When the robot 20 is caused to execute the gesture “shake head”, firstly, after 100 ms, the gesture controller 113 controls the twist motor 221 and the vertical motor 222 so that the angles are 0 degrees, then, after 100 ms, controls the driver 220 so that the angle of the twist motor 221 is 34 degrees and, then, after 100 ms, controls the driver 220 so that the angle of the twist motor 221 is −34 degrees.

Furthermore, the gesture information 121 illustrated in FIG. 12 defines, as gestures of greater complexity, gestures such as “be surprised”, “be happy”, “be sad” and the like. When causing the robot 20 to execute the gesture “be surprised”, firstly, after 100 ms, the gesture controller 113 controls the twist motor 221 and the vertical motor 222 so that the angles are 0 degrees and, then, after 100 ms, controls so that the angle of the vertical motor 222 is −24 degrees. Then, the gesture controller 113 does not rotate for 700 ms thereafter, and then controls so that, after 500 ms, the angle of the twist motor 221 is 34 degrees and the angle of the vertical motor 222 is −24 degrees. Then, the gesture controller 113 controls so that, after 400 ms, the angle of the twist motor 221 is −34 degrees and then controls so that, after 500 ms, the angles of the twist motor 221 and the vertical motor 222 are 0 degrees. Additionally, in parallel with the driving of the twist motor 221 and the vertical motor 222 described above, the gesture controller 113 outputs the sound “AHHH!” at a volume of 70 dB from the speaker 231. Note that, in FIG. 12, the gesture control parameters of the gestures such as “be happy”, “be sad”, and the like are omitted, but, as with “be surprised”, these gestures are defined by combinations of actions (motions) by the twist motor 221 and the vertical motor 222 and a sound output (animal sound) from the speaker 231.

The gesture information 121 defines, by combinations of such actions (motions) and sound outputs (animal sounds), the gestures that the robot 20 is to execute. However, a configuration is possible in which the gesture information 121 is incorporated into the robot 20 in advance. Alternatively, a configuration is possible in which the user operates the terminal device 50 to freely create the gesture information 121.

A trigger, which is a condition for the robot 20 to execute a gesture, is associated in advance with each gesture defined in the gesture information 121. Various triggers can be used, and specific examples include “there is a loud sound”, “spoken to”, “petted”, “picked up”, “turned upside down”, “became brighter”, “became darker”, and the like. These triggers are based on the external stimuli, and are detected by the sensor 210. For example, the trigger “spoken to” is detected by the microphone 213. The trigger “petted” is detected by the touch sensor 211. The triggers “picked up” and “turned upside down” are detected by the acceleration sensor 212 or the gyrosensor 214. The triggers “became brighter” and “became darker” are detected by the illuminance sensor 215. Note that a configuration is possible in which the triggers are not based on an external stimulus. Examples of such triggers include “a specific time arrived”, “the robot 20 moved to a specific location”, and the like.

The gesture controller 113 determines, on the basis of detection results and the like from the sensor 210, whether any trigger among the plurality of triggers defined in the gesture information 121 is met. When, as a result of the determination, any trigger is met, the robot 20 is caused to execute the gesture corresponding to the met trigger.

More specifically, the gesture controller 113 corrects, on the basis of the state parameters 122 acquired by the state parameter acquirer 112, the gesture control parameters identified from the gesture information 121. By doing this, it is possible to add changes to the gestures in accordance with the current state of the robot 20, and it is possible to realistically imitate a living creature.

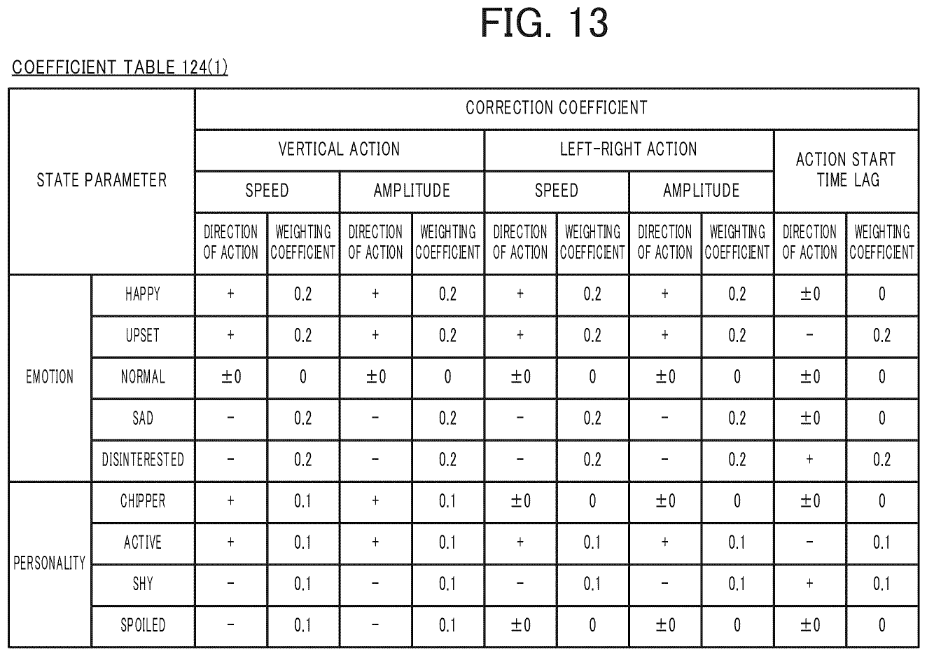

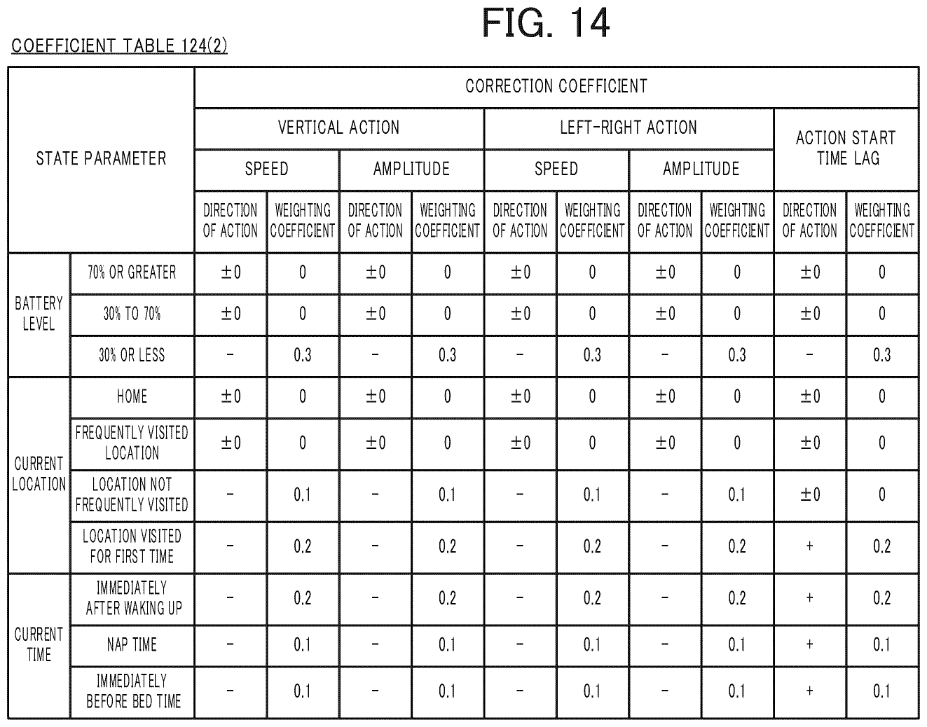

The gesture controller 113 references the coefficient table 124 to correct the gesture control parameters. As illustrated in FIGS. 13 and 14, the coefficient table 124 defines correction coefficients for each state parameter 122, namely (1) the emotion parameter, (2) the personality parameter, (3) the battery level, (4) the current location, and (5) the current time. Note that, while omitted from the drawings, the coefficient table 124 may define a correction coefficient for (6) the growth days count.

The correction coefficients are coefficients for correcting the gesture control parameters identified from the gesture information 121. Specifically, each correction coefficients are defined by an action direction and a weighting coefficient for each of a speed and an amplitude of a vertical action by the vertical motor 222, a speed and an amplitude of a left-right action by the twist motor 221, and an action start time lag.

More specifically, the gesture controller 113 determines, for the following (1) to (5), that state to which the current state of the robot 20, expressed by the state parameters 122 acquired by the state parameter acquirer 112, corresponds. Then, the gesture controller 113 corrects the gesture control parameters using the correction coefficients corresponding to the current state of the robot 20.
(1) Is the current emotion parameter of the robot 20 happy, upset, excited, sad, disinterested, or normal? In other words, are the coordinates (X, Y) expressing the emotion parameter positioned in the area labeled “happy”, “upset”, “sad”, “disinterested”, or “normal” on the emotion map 300 illustrated in FIG. 10.
(2) Is the current personality parameter of the robot 20 chipper, active, shy, or spoiled? In other words, which of the four personality values of chipper, active, shy, and spoiled is the greatest?
(3) Is the current battery level of the robot 20 70% or greater, between 70% and 30%, or 30% or less?
(4) Is the current location of the robot 20 the home, a frequently visited location, a location not frequently visited, or a location visited for the first time?
(5) Is the current time immediately after waking up, a nap time, or immediately before bed time?

As an example, in the coefficient table 124 illustrated in FIG. 14, when the current time corresponds to immediately after waking up, a direction of action of both the speed and the amplitude is defined as “−” for both the vertical action and the left-right action, and the weighting coefficient is defined as “0.2.” As such, on the basis of the values acquired from the gesture information 121, the gesture controller 113 lengthens the action time by 20% and shortens the action distance by 20%. In other words, the gesture controller 113 slows the action of the robot 20 by 20% of normal, and reduces the size of the action by 20%.

In the coefficient table 124 illustrated in FIG. 14, the direction of action of the action start time lag is defined as “+”, and the weighting coefficient is defined as “0.2.” As such, on the basis of the values set in the gesture information 121, the gesture controller 113 slows the execution start timing by 20% of normal. By correcting using such correction coefficients, the gestures are executed with somewhat slower actions than the normal actions when in a sleepy state immediately after waking up, thereby making it possible to express that sleepy state.

In addition to (5) the current time described above, the gesture controller 113 identifies, for each state, namely (1) the emotion parameter, (2) the personality parameter, (3) the battery level, and (4) the current location, the correction coefficients of the corresponding state from the coefficient table 124. Then, the gesture controller 113 corrects the gesture control parameters using the sum total of the correction coefficients corresponding to all of (1) to (5).

Next, a specific example is described in which (1) the current emotion parameter corresponds to happy, (2) the current personality parameter corresponds to chipper, (3) the current battery level corresponds to 30% or less, (4) the current location corresponds to location visited for the first time, and (5) the current time corresponds to immediately after waking up.

In this case, when referencing the coefficient table 124 illustrated in FIGS. 13 and 14, the sum total of the correction coefficients for each of the speed and the amplitude of the vertical action is calculated as “+0.2+0.1−0.3−0.2−0.2=−0.4”, and the sum total of the correction coefficients for each of the speed and the amplitude of the left-right action is calculated as “+0.2+0−0.3−0.2−0.2=−0.5.” As such, on the basis of the values set in the gesture information 121, the gesture controller 113 lengthens the action time of the vertical motor 222 by 40%, and shortens the action distance by 40%. Furthermore, on the basis of the values acquired from the gesture information 121, the gesture controller 113 lengthens the action time of the twist motor 221 by 50%, and shortens the action distance by 50%.

The sum total of the correction coefficients of the action start time lag is calculated as “+0+0+0.3+0.2+0.2=+0.7.” As such, on the basis of the values acquired from the gesture information 121, the gesture controller 113 slows the execution start timing by 70% of normal.

Note that, while omitted from the drawings, the coefficient table 124 defines a correction coefficient for the animal sound in the same manner as for the action. Specifically, the gesture controller 113 uses the correction coefficient corresponding to the state parameter 122 acquired from the state parameter acquirer 112 to correct the volume. Here, the volume is the animal sound parameter set for the gesture corresponding to the met trigger in the gesture information 121.

Thus, the gesture controller 113 corrects the gesture control parameters on the basis of the state parameters 122 acquired by the state parameter acquirer 112. Then, the gesture controller 113 causes the robot 20 to execute the gesture corresponding to the met trigger by causing the driver 220 to drive or outputting a sound from the speaker 231 on the basis of the corrected gesture control parameters. The gesture control parameters are corrected on the basis of the state parameters 122 and, as such, even when the robot 20 executes the same gesture, differences in the executed gesture occur in accordance with the current state (the emotion, the personality, the battery level, the current location, the current time, and the like) of the robot 20. For example, even when the robot 20 executes the same “be happy” gesture, differences occur in the executed gestures between when the pseudo-emotion is “happy” and when the pseudo-emotion is “upset.” Due to this, the gestures do not become uniform and individuality can be expressed.

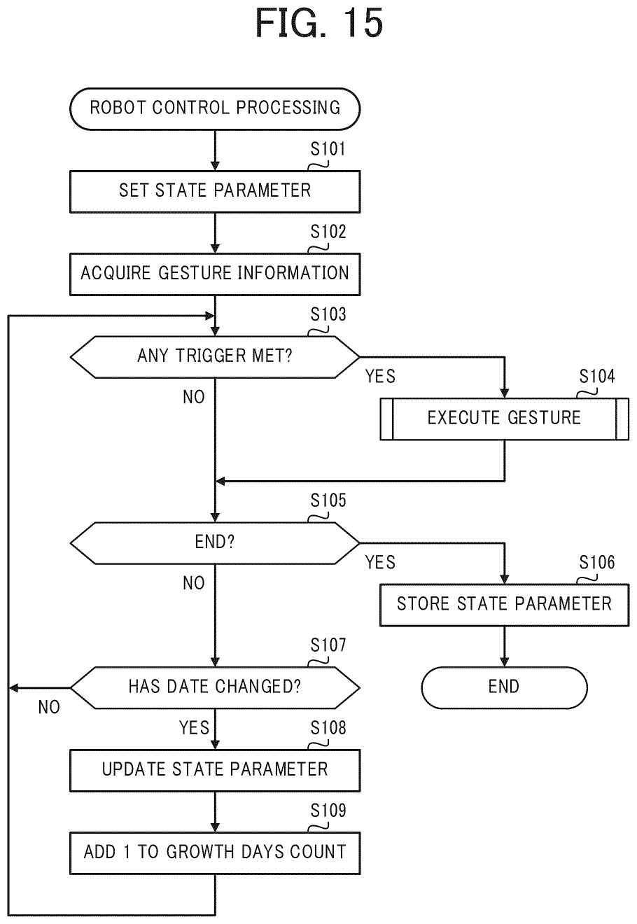

Next, the flow of robot control processing is described while referencing FIG. 15. The robot control processing illustrated in FIG. 15 is executed by the controller 110 of the control device 100, with the user turning ON the power of the robot 20 as a trigger. The robot control processing is an example of an electronic device control method.

When the robot control processing starts, the controller 110 sets the state parameters 122 (step S101). When the robot 20 is started up for the first time (the time of the first start up by the user after shipping from the factory), the controller 110 sets the various parameters, namely the emotion parameter, the personality parameter, and the growth days count to initial values (for example, 0). Meanwhile, at the time of starting up for the second and subsequent times, the controller 110 reads out the values of the various parameters stored in step S106, described later, of the robot control processing to set the state parameter 122. However, a configuration is possible in which the emotion parameters are all initialized to 0 each time the power is turned ON.

When the state parameters 122 are set, the controller 110 acquires the gesture information 121 (step S102). For example, the controller 110 communicates with the terminal device 50 and acquires the gesture information 121 created on the basis of user operations performed on the terminal device 50. Note that, when the gesture information 121 is already stored in the storage 120, step S102 may be skipped.

When the gesture information 121 is acquired, the controller 110 determines whether any trigger among the triggers of the plurality of gestures defined in the gesture information 121 is met (step S103).

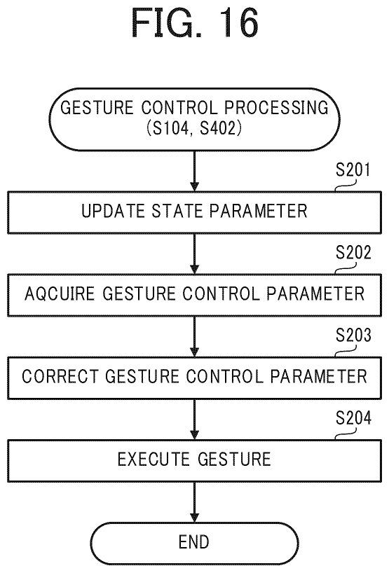

When any trigger is met (step S103; YES), the controller 110 executes the gesture control processing and causes the robot 20 to execute the gesture corresponding to the met trigger (step S104). Details about the gesture control processing of step S104 are described while referencing the flowchart of FIG. 16. Step S104 is an example of a control step.

When the gesture control processing illustrated in FIG. 16 starts, the controller 110 updates the state parameters 122 (step S201). Specifically, in a case in which the trigger met in step S103 is based on an external stimulus, the controller 110 derives the emotion change amount corresponding to that external stimulus. Then, the controller 110 adds or subtracts the derived emotion change amount to or from the current emotion parameter to update the emotion change amount. Furthermore, in the juvenile period, the controller 110 calculates, in accordance with (Equation 1) described above, the various personality values of the personality parameter from the emotion change amount updated in step S108. Meanwhile, in the adult period, the controller 110 calculates, in accordance with (Equation 2) described above, the various personality values of the personality parameter from the personality correction values and the emotion change amount updated in step S108.

When the state parameters 122 are updated, the controller 110 references the gesture information 121 and acquires the gesture control parameters of the gesture corresponding to the met trigger (step S202). Specifically, the controller 110 acquires, from the gesture information 121, the action parameter or the animal sound parameter, and the execution time length thereof, of the elements constituting the gesture corresponding to the met trigger.

When the gesture control parameters are acquired, the controller 110 corrects the gesture control parameters on the basis of the correction coefficients defined in the coefficient table 124 (step S203). Specifically, the controller 110 calculates the sum total of the correction coefficients corresponding to the state parameters 122 updated in step S201 among the correction coefficients defined in the coefficient table 124 for each of (1) the emotion parameter, (2) the personality parameter, (3) the battery level, (4) the current location, and (5) the current time. Then, the controller 110 corrects the action parameter, the animal sound parameter, and the execution start timing with the calculated sum total of the correction coefficients.

When the gesture control parameters are corrected, the controller 110 executes the gesture corresponding to the met trigger (step S204). Specifically, the controller 110 causes the driver 220 to drive or outputs a sound from the speaker 231 in accordance with the gesture control parameters corrected in step S203. Thus, the gesture control processing illustrated in FIG. 16 is ended.

Returning to FIG. 15, in step S103, when no trigger among the triggers of the plurality of gestures is met (step S103; NO), the controller 110 skips step S104.

Next, the controller 110 determines whether to end the processing (step S105). For example, when the operator 240 receives a power OFF command of the robot 20 from the user, the processing is ended. When ending the processing (step S105; YES), the controller 110 stores the current the state parameters 122 in the non-volatile memory of the storage 120 (step S106), and ends the robot control processing illustrated in FIG. 15.

When not ending the processing (step S105; NO), the controller 110 uses the clock function to determine whether a date has changed (step S107). When the date has not changed (step S107; NO), the controller 110 executes step S103.

When the date has changed (step S107; YES), the controller 110 updates the state parameters 122 (step S108). Specifically, when it is during the juvenile period (for example, 50 days from birth), the controller 110 changes the values of the emotion change amounts DXP, DXM, DYP, and DYM in accordance with whether the emotion parameter has reached the maximum value or the minimum value of the emotion map 300. Additionally, when in the juvenile period, the controller 110 increases both the minimum value and the maximum value of the emotion map 300 by a predetermined increase amount (for example, 2). In contrast, when in the adult period, the controller 110 adjusts the personality correction values.

When the state parameters 122 are updated, the controller 110 adds 1 to the growth days count (step S109), and executes step S103. Then, as long as the robot 20 is operating normally, the controller 110 repeats the processing of steps S103 to S109.

### Imaging Mode

Next, an imaging mode in which the parameters such as the personality parameter, the growth parameter, and the like are set, and video capturing is carried out by the imager 560 of the terminal device 50 with the robot 20, that executes the various gestures in accordance with the parameters, as the imaging subject. In the imaging mode, the terminal device 50 is an example of an imaging device communicably connected to the robot 20 that is the imaging subject, and the robot system 1 is an example of an imaging system.

In the terminal device 50 illustrated in FIG. 9, the imaging controller 513 controls the imaging carried out by the imager 560. Specifically, the imaging controller 513 controls the imager 560 and causes the imager 560 to carry out video imaging of the robot 20 that is the imaging subject.

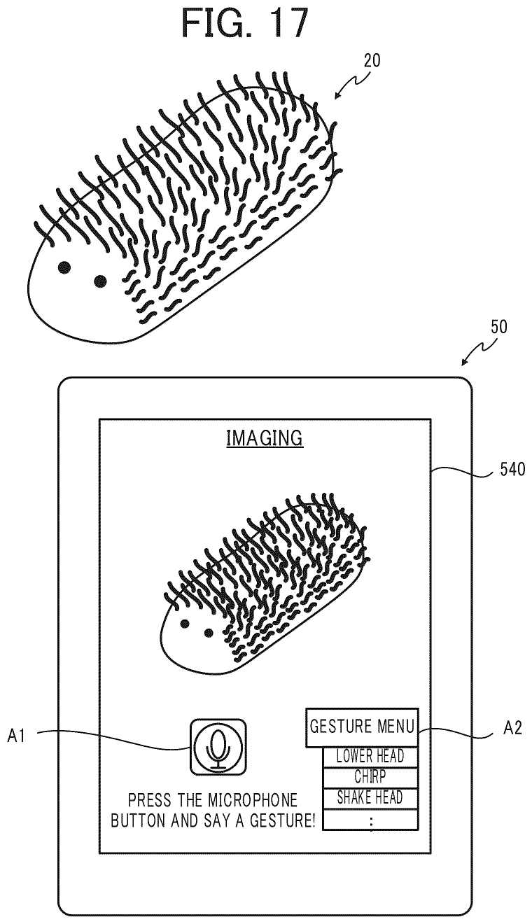

In a case in which the user desires to capture a video of the robot 20, as illustrated in FIG. 17, the user directs the imager 560 of the terminal device 50 in the direction of the robot 20, and images the robot 20 using the imager 560. At this time, the imaging controller 513 starts the imaging mode when the user operates the operator 530 of the terminal device 50 to start up an application/software for video imaging.

In the imaging mode, the imaging controller 513 displays an imaging mode screen illustrated in FIG. 17 on the display 540. The imaging controller 513 displays, in the imaging mode screen, a preview image captured by the imager 560.

When the imaging mode is started, the imaging controller 513 sends a notification indicating that the imaging mode is started to the control device 100 of the robot 20 via the communicator 550. More specifically, after the imaging mode is started, when an incline of the terminal device 50 is an incline suitable for imaging and, also, the presence of the robot 20 in a captured image obtained by preview imaging is recognized by image recognition, the imaging controller 513 sends, to the robot 20, the notification indicating that the imaging mode is started. Note that the incline suitable for imaging is an orientation of the terminal device 50 that the terminal device 50 is typically likely to be placed in when imaging and, for example, corresponds to an orientation of the terminal device 50 in a state in which the imaging direction of the imager 560 is within a predetermined range from the horizontal direction.

In the control device 100 of the robot 20, upon receiving the notification from the terminal device 50, the gesture controller 113 causes the robot 20 to execute a pre-imaging gesture. Here, the pre-imaging gesture is a gesture that the robot 20 executes prior to the video imaging. The gesture controller 113 executes the pre-imaging gesture continuously, intermittently, or on a random cycle from when the notification of the start of the imaging mode is received to when the video imaging starts.

For example, when the personality value of shy of the personality parameter of the robot 20 is the greatest, or when the current location of the robot 20 is a location visited for the first time, the gesture controller 113 causes the robot 20 to execute a gesture expressing embarrassment as the pre-imaging gesture. Alternatively, when the personality value of active is the greatest, the gesture controller 113 causes the robot 20 to execute a gesture expressing a pose prompting imaging as the pre-imaging gesture. At this time, the gesture controller 113 may control the type of the pre-imaging gesture, the size of the action, and the like to demonstrate, for example, a level of embarrassment in accordance with the level of the personality value of shy.

Thus, the gesture controller 113 causes the robot 20 to execute various different gestures in accordance with the state parameters 122 such as the emotion parameter, the personality parameter, the battery level, the current location, the current time, and the like. The gesture controller 113 may change the pre-imaging gesture on the basis of only one parameter among the state parameters 122, or may change the pre-imaging gesture on the basis of a plurality of parameters among the state parameters 122. Additionally, the gesture controller 113 may correct the gesture control parameters of the pre-imaging gesture on the basis of the coefficient table 124 as described above,

Returning to FIG. 9, in the terminal device 50, the gesture selector 514 selects the gesture that the robot 20 is to be caused to execute at the time of the video imaging the robot 20 that is the imaging subject. It is possible to select, by speech input or menu display, the gesture that robot 20 is to be caused to execute at the time of the video imaging from among the plurality of gestures executable by the robot 20. The plurality of gestures executable by the robot 20 are the gestures such as “lower head”, “chirp”, “shake head”, and the like defined in the gesture information 121. The gesture information 121 is stored in the storage 120 of the robot 20, but is shared with the storage 520 of the terminal device 50. The gesture selector 514 references the gesture information 121 stored in the storage 520 when selecting the gesture.

Firstly, when selecting the gesture by speech input, the user selects (taps) the microphone-shaped icon A1 in the imaging mode screen illustrated in FIG. 17, and utters speech of a gesture name of the gesture that the user desires the robot 20 to execute. The gesture selector 514 detects, by the microphone (omitted in the drawing) of the terminal device 50, the speech uttered by the user. Then, the gesture selector 514 determines, by speech recognition, whether the speech detected by the microphone includes any gesture name of the gesture names of the plurality of gestures executable by the robot 20. Here, the gesture name is a word for identifying each gesture such as “lower head”, “chirp”, “shake head”, “be surprised”, “be happy”, “be sad”, and the like. When any gesture name is included in the detected speech, the gesture selector 514 selects the gesture of that gesture name as the gesture that the robot 20 is to be caused to execute.

Secondly, when selecting the gesture by menu display, the user selects the “gesture menu” icon A2 in the imaging mode screen illustrated in FIG. 17. Upon selection, the gesture names of the plurality of gestures executable by the robot 20 are displayed in, for example, a pull-down format. The user selects, from among the displayed plurality of gesture names, the gesture name of the gesture that the user desires the robot 20 to execute.

Thus, the gesture selector 514 can select the gesture by speech input or menu display. However, in order to reduce obstructions to the lifelikeness of the robot 20, it is preferable that the gesture is selected by speech input.

Note that, when the gesture selector 514 selects the gesture by speech input, the user is not limited to inputting speech that perfectly matches the gesture name of the gesture that the robot 20 is to be caused to execute. For example, when selecting the gesture “shake head”, the user may input speech of “shake your head!”. Alternatively, when selecting the gesture “chirp”, the user may input speech of “chirp for me!”, and when selecting the gesture “be happy”, the user may input the speech “cheer up!” or the like. Thus, even when speech, for which a portion, such as the ending or the like, of the word/phrase differs from the gesture name, is input, the gesture selector 514 can identify the gesture corresponding to the inputted speech, provided that the difference is such that the gesture can be identified.

Alternatively, the user may input, into the microphone, a keyword that can identify the gesture that the robot 20 is to be caused to execute. In such a case, the gesture selector 514 selects, as the gesture that the robot 20 is to be caused to execute, the gesture identified from the keyword detected by the microphone. The keyword is a word related to the gesture, such as a synonym of the gesture name, a word associated with the gesture name, or the like. At least one keyword is associated in advance with at least a portion of the plurality of gestures defined in the gesture information 121. When a keyword associated with any gesture is included in the detected speech, the gesture selector 514 selects that gesture as the gesture that the robot 20 is to be caused to execute.

As an example, the keyword “ghost” is associated with the gesture “be surprised”, and the keyword “2” is associated with the gesture “speak two times.” When the speech “A ghost!” is detected, the gesture selector 514 selects action “be surprised” as the gesture that the robot 20 is to be caused to execute. Alternatively, when the speech “what is 1+1?” is detected, the gesture selector 514 selects the gesture “speak two times” as the gesture that the robot 20 is to be caused to execute. By configuring such that the gestures are selectively recognized by keywords, the robot 20 can demonstrate a higher degree of lifelikeness.

The gesture selector 514 selects, by the speech input or the menu input described above, at least one gesture that the robot 20 is to be made to execute from among the plurality of gestures executable by the robot 20. For example, the gesture selector 514 can simultaneously select three gestures as the gesture that the robot 20 is to be caused to execute.

When at least one gesture is selected by the gesture selector 514, the imaging controller 513 causes the robot 20 to execute the selected at least one gesture and, also, causes the imager 560 to perform video imaging with the robot 20 as the subject. At this time, the imaging controller 513 causes the imager 560 to perform the video imaging with the robot 20 as the subject for an amount of time corresponding to the at least one gesture selected by the gesture selector 514 so as to enable capturing, from the start to the end of the gesture, of the appearance of the robot 20 executing the at least one gesture selected by the gesture selector 514. Specifically, the imaging controller 513 sets an imaging time length that is the length of an amount of time required to capture a video of the selected at least one gesture. The imaging controller 513 references the gesture information 121 in order to set the imaging time length. As illustrated in FIG. 12, the gesture information 121 defines the execution time length for each of the plurality of gestures executable by the robot 20. The execution time length of each gesture is a time length required for that gesture, from start to end by the robot 20.

More specifically, when there is one element (action or animal sound) constituting a certain gesture, the execution time length set for that gesture corresponds to the execution time length of that element, and when there is a plurality of elements (actions and/or animal sounds) constituting that gesture, the execution time length of set for that gesture corresponds to the sum of the execution time lengths of those elements. For example, the execution time length of the gesture “lower head” is 100+100 ms=200 ms, the execution time length of the gesture “chirp” is 300 ms, and the execution time length of the gesture “shake head” is 100+100+100 ms=300 ms.

The imaging controller 513 acquires, from the gesture information 121, the execution time length set to each of the at least one gestures selected by the gesture selector 514, and sets the imaging time length. For example, when one gesture is selected by the gesture selector 514, the execution time length set to that one gesture in the gesture information 121, or a time length obtained by adding a certain amount of grace time to that execution time length is set as the imaging time length. Meanwhile, when a plurality of gestures is selected by the gesture selector 514, the imaging controller 513 sets, as the imaging time length, the sum of the execution time lengths set to each gesture of the plurality of gestures in the gesture information 121, or a time length obtained by adding a certain grace time to that sum of the execution time lengths. By providing the grace time, the amount of time that the robot 20 executes the gesture can be kept within the imaging time length, even when the time that the robot 20 executes the gesture is extended due to corrections, based on the coefficient table 124, of the gesture control parameters.

Next, the imaging controller 513 receives a start command of the video imaging from the user. The user selects (taps) an imaging start button displayed in the imaging mode screen. Alternatively, the user can input, by speech, an imaging start call such as “start imaging” or the like. Thus, the user inputs the start command of the video imaging into the terminal device 50. The imaging controller 513 receives the start command of the video imaging on the basis of such user operations.

When the start command of the video imaging is received, the imaging controller 513 causes the imager 560 to start the video imaging with the robot 20 as the imaging subject. Furthermore, at a timing linked to the timing of the start of the video imaging, the imaging controller 513 sends, to the robot 20 that is the imaging subject, an execution command for causing the robot 20 to execute the gesture selected by the gesture selector 514.

The execution command is a command for causing the robot 20 to start the gesture selected by the gesture selector 514 at a timing based on the timing at which the imager 560 starts the video imaging. The execution command includes information about the gesture name of the at least one gesture selected by the gesture selector 514. Note that a configuration is possible in which, instead of the gesture name, the execution command includes information such as a number, an ID, or the like, provided that the information is capable of uniquely identifying the at least one gesture selected by the gesture selector 514.

The timing at which the robot 20 is caused to start the gesture selected by the gesture selector 514 is adjusted on the basis of the timing at which the imager 560 performs the video imaging so as to enable capturing, from the start to the end of the gesture, of the appearance of the robot 20 executing the gesture selected by the gesture selector 514 in the video. Specifically, the imaging controller 513 adjusts the timing at which the imager 560 starts the video imaging and the timing at which the robot 20 starts the gesture such that the timing at which the robot 20 starts the gesture is the same or slightly later than the timing at which the imager 560 starts the video imaging. When the imager 560 is caused to start the video imaging, the imaging controller 513 sends the execution command to the robot 20 at a timing that is the same or slightly later than that timing.

In the control device 100 of the robot 20, upon receiving the execution command from the terminal device 50, the gesture controller 113 causes the robot 20 to execute the gesture of the gesture name indicated in the received execution command. In other words, the gesture controller 113 causes the robot 20 to start the gesture selected by the gesture selector 514 at a timing based on the timing at which the imager 560 starts the video imaging. Note that, when a plurality of gestures is selected by the gesture selector 514, the gesture controller 113 causes the robot 20 to sequentially execute the plurality of gestures.

At this time, as with the case in which any trigger is met outside the imaging mode, the gesture controller 113 acquires, from the gesture information 121, the gesture control parameters of the gesture commanded to be executed, and corrects the gesture control parameters using the correction coefficients defined in the coefficient table 124 illustrated in FIGS. 13 and 14. At this time, the gesture controller 113 corrects the gesture control parameters using the correction coefficients corresponding to the state parameters 122 acquired by the state parameter acquirer 112. The details of the correction using the correction coefficients are the same as those when outside the imaging mode, described above. Then, the gesture controller 113 causes the robot 20 to execute, using the corrected gesture control parameters, the gesture commanded to be executed. The gesture control parameters are corrected on the basis of the state parameters 122 and, as such, even when the robot 20 executes the same gesture, differences in the executed gesture occur in accordance with the current state (the emotion, the personality, the battery level, the current location, the current time, and the like) of the robot 20.

Thus, the gesture that the gesture controller 113 causes the robot 20 to execute changes in accordance with the current state parameters 122 and the growth parameter of the robot 20. As such, gestures that reflect individuality and are not uniform can be executed.

In the terminal device 50, the imaging controller 513 causes the imager 560 to start the video imaging and, then, causes the imager 560 to end the video imaging at a timing corresponding to the timing at which the robot 20 ends the gesture. The timing corresponding to the timing at which the robot 20 ends the gesture is a timing that is the same or slightly later than the timing at which the robot 20 ends the gesture being executed so as to enable capturing, from the start to the end of the gesture, of the appearance of the gesture executed by the robot 20 in the video. The imaging controller 513 causes the imager 560 to end the video imaging at a timing that is the same or slightly later than the timing at which the execution of the at least one gesture selected by the gesture selector 514 ends.

More specifically, the imaging controller 513 causes the imager 560 to end the video imaging at a timing after an amount of time, based on the time length set for the at least one gesture selected by the gesture selector 514, from the timing at which the imager 560 started the video imaging. Here, the amount of time based on the time length set for the at least one gesture selected by the gesture selector 514 is the imaging time length set on the basis of the execution time length set in gesture information 121.

The imaging controller 513 measures an elapsed time at the same time as the timing at which the imager 560 is caused to start the video imaging, and causes the imager 560 to end the video imaging at a timing at which the set imaging time length has elapsed. As a result, it is possible to capture, from the start to the end of the gesture and without excess, the appearance of the robot 20 executing the at least one gesture selected by the gesture selector 514 in the video. In other words, it is possible to prevent the states before the robot 20 starts and after the robot 20 ends the gesture (for example, states in which the robot 20 is not doing anything, and the like) from being unnecessarily imaged.

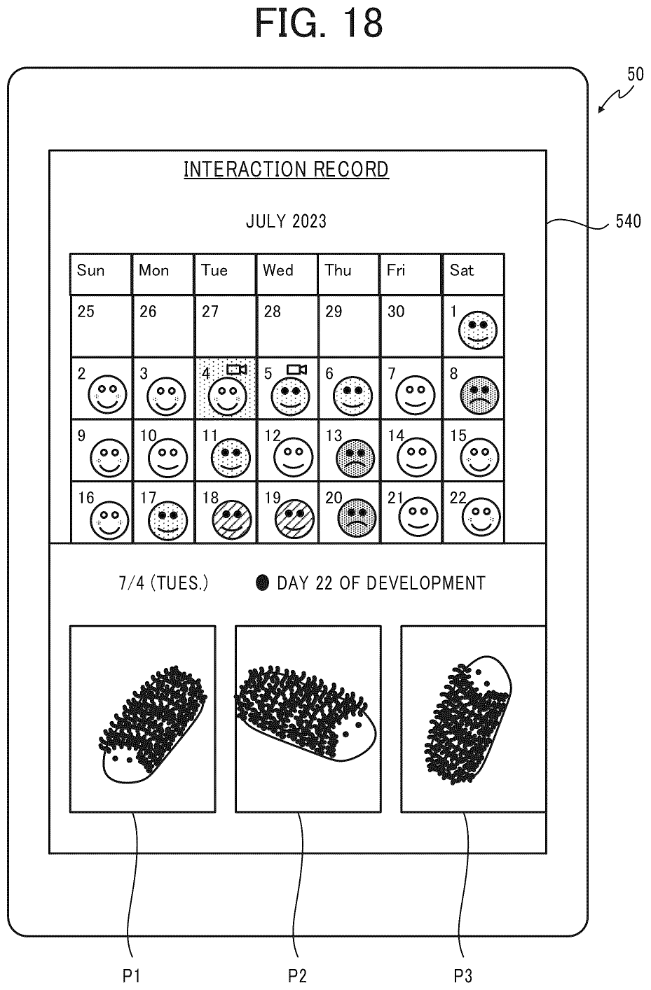

When the imager 560 is caused to end the video imaging, the imaging controller 513 stores the obtained video in the storage 520. The video obtained by the video imaging can be played back in a video playback screen illustrated in FIG. 18.

In the upper portion of the video playback screen, the imaging controller 513 displays, in the form of a calendar, a plurality of days on which the video imaging of the robot 20 is performed. When the user selects any day among the plurality of days by operating the operator 530, the imaging controller 513 displays, in the lower portion of the video playback screen, thumbnail images P1 to P3 of the video captured on the selected day.

Each of the thumbnail images P1 to P3 is an image for identifying the video. When the user selects any of the thumbnail images P1 to P3, the imaging controller 513 plays back a video corresponding to the selected thumbnail image.

Note that a configuration is possible in which, so that the user can easily ascertain the content of the video before playing back the video, the imaging controller 513 displays, overlaid on each of the thumbnail images P1 to P3, information related to the gesture that the robot 20 is executing in the video corresponding to that thumbnail image. The information related to the gesture is, for example, information such as text, a shape, an image, or the like whereby the user can identify the gesture that the robot 20 is executing in the video.

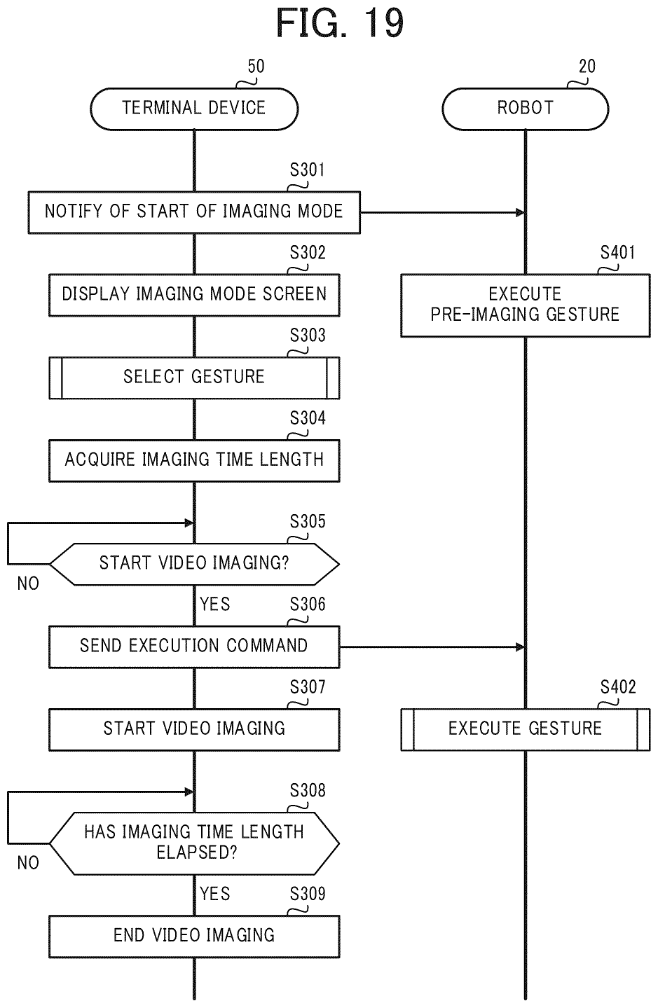

Next, the flow of video capturing processing with the robot 20 as the imaging subject is described while referencing FIG. 19. The video capturing processing illustrated in FIG. 19 starts upon the user that desires to capture a video of the robot 20 operating the terminal device 50 and starting the imaging mode.

When the video capturing processing starts, in the terminal device 50, the controller 510 communicates with the robot 20 via the communicator 550 and notifies the robot 20 of the starting of the imaging mode (step S301).

When the robot 20 is notified of the starting of the imaging mode, the controller 510 displays, for example, the imaging mode screen illustrated in FIG. 17 on the display 540 (step S302).

In the control device 100 of the robot 20, when the controller 110 receives the notification of the starting of the imaging mode from the terminal device 50, the controller 110 causes the robot 20 to execute the pre-imaging gesture (step S401).

In the terminal device 50, when the controller 510 displays the imaging mode screen, the gesture that the robot 20 is to be caused to execute is selected (step S303). Specifically, the controller 510 receives, from the user and by speech input or by menu display, the selection of at least one gesture that the robot 20 is to be caused to execute at the time of the video imaging, from among the plurality of gestures executable by the robot 20.

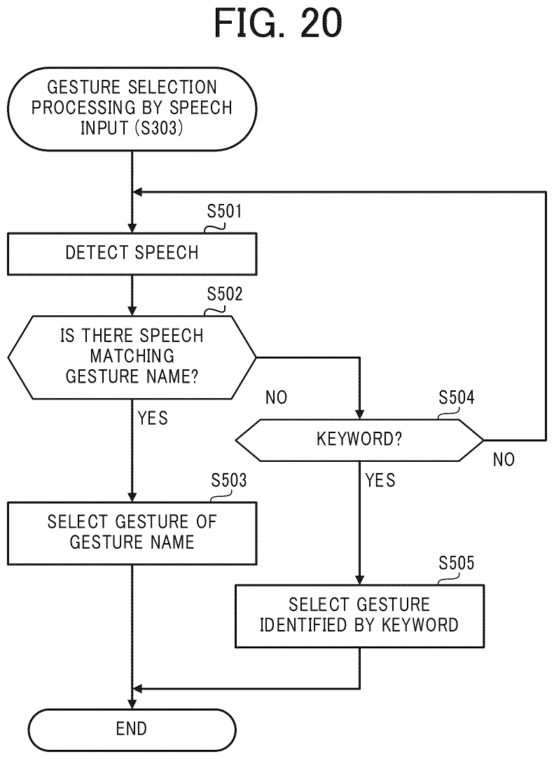

Details of the gesture selection processing when using speech input in step S303 are described while referencing FIG. 20.

When the gesture selection processing illustrated in FIG. 20 starts, the controller 510 detects the speech by the microphone (step S501). Next, the controller 510 determines whether the detected speech includes speech matching any among the gesture names of the plurality of gestures executable by the robot 20 (step S502). When speech matching any gesture name is included in the detected speech (step S502; YES), the controller 510 selects the gesture of the gesture name (step S503).

Meanwhile, when speech matching any gesture name is not included in the detected speech (step S502; NO), next, the controller 510 determines whether the detected speech includes a keyword associated with any gesture (step S504). When a keyword is included in the detected speech (step S504; YES), the controller 510 selects the gesture associated with that keyword (step S505).

When a keyword is not included in the detected speech (step S504; NO), the controller 510 executes step S502 without selecting a gesture. A configuration is possible in which, at this time, the controller 510 notifies the robot 20 that a gesture could not be recognized from the speech, and causes the robot 20 to execute a gesture expressing that recognition has failed. Thus, the gesture selection processing by speech input illustrated in FIG. 20 is ended.

Returning to FIG. 19, when a gesture is selected in step S303, the controller 510 references the gesture information 121 and sets the imaging time length for video imaging the robot 20 that executes the selected gesture (step S304).

When the imaging time length is set, the controller 510 determines whether the start command of the video imaging is received from the user (step S305). When the start command is not received (step S305; NO), the controller 510 remains at step S305 and stands by until the start command is received.

When the start command is received (step S305; YES), the controller 510 starts the video imaging by the imager 560 (step S307). Furthermore, the controller 510 sends, at the timing linked to the timing of the starting of the video imaging, the execution command of the selected gesture to the robot 20 (step S306).

In the control device 100 of the robot 20, when the controller 110 receives the execution command from the terminal device 50, the controller 110 causes the robot 20 to execute the selected gesture (step S402). In step S402, as in step S104, the controller 110 executes the gesture control processing illustrated in FIG. 16 (steps S201 to S205).

In the terminal device 50, when the video imaging starts, the controller 510 determines whether the imaging time length set in step S304 has elapsed from when the video imaging is started (step S308). When the imaging time length has not elapsed (step S308; NO), the controller 510 remains at step S308 and continues the video imaging until the imaging time length elapses.

When the imaging time length has elapsed (step S308; YES), the controller 510 ends the video imaging (step S309). Thus, the video capturing processing illustrated in FIG. 19 is ended.

As described above, the terminal device 50 according to Embodiment 1 selects the gesture that the robot 20 is to be caused to execute, causes the robot 20 to execute the selected gesture, and causes the imager 560 to end the video imaging at the timing corresponding to the timing at which the robot 20 ends the gesture. As a result, it is possible to prevent unnecessary imaging of the state after the robot 20 has ended the gesture and, thus, it is possible to perform video imaging of the robot 20 at accurate timings.

In particular, when imaging the robot 20 that executes spontaneous gestures, the timing of gesture execution is arbitrary. As such, in conventional methods, in order to image only a desired gesture, it is necessary to perform imaging that includes before and after the timing at which the gesture is predicted to be executed and, thereafter, perform editing such as selecting only the required portion. In contrast, the terminal device 50 according to Embodiment 1 can make the timing at which the robot 20 ends the gesture and the timing at which the video imaging is ended match and, as such, can easily video image the robot 20 executing a desired gesture.

### Embodiment 2

Next, Embodiment 2 is described. In Embodiment 2, as appropriate, descriptions of configurations and functions that are the same as described in Embodiment 1 are forgone.

In Embodiment 1, the terminal device 50 is provided with the functions of the gesture selector 514, and the gesture that the robot 20 is to be caused to execute is selected in the terminal device 50. In contrast, in Embodiment 2, the control device 100 of the robot 20 is provided with the functions of the gesture selector 514. In other words, in Embodiment 2, the controller 110 functionally includes the state parameter acquirer 112, the gesture controller 113, and the gesture selector 514, and the controller 510 functionally includes the imaging controller 513.

Specifically, a case is described in which the gesture selector 514 selects, by speech input, a gesture that the robot 20 is to be caused to execute. In the control device 100 of the robot 20 according to Embodiment 2, the gesture selector 514 detects speech of the user by the microphone 213 of the robot 20. Moreover, for the detected speech, the gesture selector 514 executes gesture selection processing by speech input illustrated in FIG. 20, and selects the gesture that the robot 20 is to be caused to execute.

When the gesture selector 514 selects the gesture, the gesture controller 113 sends, to the terminal device 50, a notification for starting the imaging mode in order to make the timing at which the robot 20 is caused to execute the selected gesture and the timing of the video imaging match. That is, in Embodiment 1, the notification of the starting of the imaging mode is sent from the terminal device 50 to the robot 20 but, in Embodiment 2, the notification of the starting of the imaging mode is sent from the robot 20 to the terminal device 50.

In the terminal device 50, when the notification of the starting of the imaging mode is received, the imaging controller 513 starts the video imaging by the imager 560. In synchronization with this timing, in the control device 100 of the robot 20, the gesture controller 113 causes the robot 20 to execute the gesture selected by the gesture selector 514.

Thus, even in a case in which the robot 20 is provided with the functions of the gesture selector 514, it is possible to make the timing of the video imaging and the timing at which the robot 20 is caused to execute the gesture match and, thus, it is possible to perform video imaging of the robot 20 at accurate timings.

### Modified Examples

Embodiments of the present disclosure are described above, but these embodiments are merely examples and do not limit the scope of application of the present disclosure. That is, various applications of the embodiments of the present disclosure are possible, and all embodiments are included in the scope of the present disclosure.

For example, in the embodiments described above, the imaging controller 513 causes the imager 560 to end the video imaging at a timing after the imaging time length that is an amount of time, based on the time length set for the at least one gesture selected by the gesture selector 514, from the timing at which the imager 560 starts the video imaging. However, the timing of the ending of the video imaging of is not limited thereto.

For example, in the control device 100 of the robot 20, at the timing at which the robot 20 ends the gesture selected by the gesture selector 514, the gesture controller 113 sends, to the terminal device 50, the notification indicating that the gesture is ended. In the terminal device 50, when this notification is received, the imaging controller 513 causes the imager 560 to end the video imaging. The notification of the ending of the gesture is sent from the robot 20 side in this manner and, as such, the imaging controller 513 can cause the imager 560 to end the video imaging at an accurate timing, without setting the imaging time before starting of the video imaging.

Alternatively, a configuration is possible in which the imaging controller 513 determines whether the robot 20 has ended the gesture on the basis of the video obtained by the video imaging, and causes the imager 560 to end the video imaging when a determination is made that the robot 20 has ended the gesture selected by the gesture selector 514. Specifically, the imaging controller 513 analyzes, by image recognition, the video in which the appearance of the robot 20 executing the gesture is captured. Then, when the action of the robot 20 in the video has stopped, the imaging controller 513 determines that the robot 20 has ended the gesture. As a result, the imager 560 can be caused to end the video imaging at an accurate timing, without setting the imaging time or receiving a notification from the robot 20.

Furthermore, a configuration is possible in which the imaging controller 513 corrects the timing, at which to cause the imager 560 to end the video imaging, so as to be in conjunction with the correction of the gesture control parameters of the robot 20. Specifically, in the robot 20, the gesture controller 113 corrects the gesture control parameters using, among the correction coefficients defined in the coefficient table 124, the correction coefficients corresponding to the state parameters 122 obtained by the state parameter acquirer 112. At this time, depending on the execution start timing, the execution time length of the gesture may become longer or shorter. When, due to the correction of the gesture control parameters, the execution time length of the gesture to be executed by the robot 20 changes from the execution time length defined in the gesture information 121, the gesture controller 113 sends, to the terminal device 50, correction information indicating that a change has occurred. The send correction information includes, in addition to the information indicating that the execution time length has changed, information about an amount of change of the execution time length.

When the correction information is received from the robot 20, the imaging controller 513 corrects, on the basis of the received correction information, the timing at which to end the video imaging. For example, when the corrected execution time length has become longer than the execution time length defined in the gesture information 121, the imaging controller 513 makes the timing at which to end the video imaging later an amount corresponding to the amount of change of the execution time length from the imaging time length initially set. Alternatively, when the corrected execution time length has become shorter than the execution time length defined in the gesture information 121, the imaging controller 513 makes the timing at which to end the video imaging earlier by an amount corresponding to the amount of change of the execution time length from the imaging time length initially set. By correcting the imaging time length in this manner, it is possible to perform video imaging of the robot 20 at accurate timings, even when the execution time length of the gesture has changed due to the state of the robot 20.

In the embodiments described above, one robot 20 is video imaged as the imaging subject, but it is possible to video image a plurality of robots 20 simultaneously as the imaging subject. In such a case, each robot 20 of the plurality of robots 20 can execute a gesture as in, for example, (a) to (d) below:
(a) When the personality value of “shy” of a certain robot 20 is greater than or equal to a predetermined level, that robot 20 executes a gesture that matches the emotion parameters or the personality values of the surrounding robots 20;
(b) When the personality value of “active” of a certain robot 20 is greater than or equal to a predetermined level, that robot 20 executes a gesture defined for that robot 20, regardless of the surrounding robots 20;
(c) When the current location is a location visited for the first time, that robot 20 executes a gesture that matches the emotion parameters or the personality parameters of the surrounding robots 20 and, when the current location is the home, that robot 20 executes a gesture defined for that robot 20; and
(d) When executing a gesture matching the emotion parameters or the personality parameters of the surrounding robots 20, in a case in which there are three or more robots 20 including the certain robot 20, the certain robot 20 executes a gesture matching the emotion parameters or the personality parameters that have majority-based dominance.

In the embodiment described above, the control device 100 is installed in the robot 20, but a configuration is possible in which the control device 100 is not installed in the robot 20 but, rather, is a separated device (for example, a server). When the control device 100 is provided outside the robot 20, the control device 100 communicates with the robot 20 via the communicator 130, the control device 100 and the robot 20 send and receive data to and from each other, and the control device 100 controls the robot 20 as described in the embodiments described above.

In the embodiment described above, the exterior 201 is formed in a barrel shape from the head 204 to the torso 206, and the robot 20 has a shape as if lying on its belly. However, the robot 20 is not limited to resembling a living creature that has a shape as if lying on its belly. For example, a configuration is possible in which the robot 20 has a shape provided with arms and legs, and resembles a living creature that walks on four legs or two legs.

Furthermore, the electronic device is not limited to a robot 20 that imitates a living creature. For example, provided that the electronic device is a device capable of expressing individuality by executing various gestures, a configuration is possible in which the electronic device is a wristwatch or the like. Even for an electronic device other than the robot 20, it is possible to described that electronic device in the same manner as in the embodiments described above by providing the same configurations and functions as with the robot 20 described above,

In the embodiment described above, in the controller 110, the CPU executes programs stored in the ROM to function as the various components, namely, the state parameter acquirer 112, the gesture controller 113, and the like. Additionally, in the controller 510, the CPU executes programs stored in the ROM to function as the various components of the imaging controller 513. However, in the present disclosure, the controller 110, 510 may include, for example, dedicated hardware such as an Application Specific Integrated Circuit (ASIC), a Field-Programmable Gate Array (FPGA), various control circuitry, or the like instead of the CPU, and this dedicated hardware may function as the various components, namely the state parameter acquirer 112 and like. In this case, the functions of each of the components may be realized by individual pieces of hardware, or the functions of each of the components may be collectively realized by a single piece of hardware. Additionally, the functions of each of the components may be realized in part by dedicated hardware and in part by software or firmware.

It is possible to provide a robot 20 or a terminal device 50, provided in advance, with the configurations for realizing the functions according to the present disclosure, but it is also possible to apply a program to cause an existing information processing device or the like to function as the robot 20 or the terminal device 50 according to the present disclosure. That is, a configuration is possible in which a CPU or the like that controls an existing information processing apparatus or the like is used to execute a program for realizing the various functional components of the robot 20 or the terminal device 50 described in the foregoing embodiments, thereby causing the existing information processing device to function as the robot 20 or the terminal device 50 according to the present disclosure.

Additionally, any method may be used to apply the program. For example, the program can be applied by storing the program on a non-transitory computer-readable recording medium such as a flexible disc, a compact disc (CD) ROM, a digital versatile disc (DVD) ROM, and a memory card. Furthermore, the program can be superimposed on a carrier wave and applied via a communication medium such as the internet. For example, the program may be posted to and distributed via a bulletin board system (BBS) on a communication network. Moreover, a configuration is possible in which the processing described above is executed by starting the program and, under the control of the operating system (OS), executing the program in the same manner as other applications/programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. An imaging system comprising:
a camera; and
at least one processor;
wherein
the at least one processor
in a case in which a gesture, that a robot is to be caused to execute at a time of video capturing, is selected from among a plurality of gestures registered in advance and, also, video capturing by the camera is to be started with the robot as a subject, controls the video capturing by the camera so that the video capturing ends at a timing corresponding to a timing at which the robot ends the gesture.

2. The imaging system according to claim 1, wherein
the at least one processor
upon the gesture that the robot is to be caused to execute being selected from among the plurality of gestures registered in advance, sends a signal instructing an execution start of the gesture to the robot in conjunction with a start of the video imaging.

3. The imaging system according to claim 2, comprising:
the robot, wherein
the robot starts execution of the gesture upon receiving of the signal instructing the execution start of the gesture.

4. The imaging system according to claim 2, wherein
the at least one processor
ends the video imaging at the timing corresponding to the timing at which the robot ends the gesture by ending, based on an execution time length registered in advance in association with the gesture, the video imaging by the camera.

5. The imaging system according to claim 2, wherein
the at least one processor
ends the video imaging at the timing corresponding to the timing at which the robot ends the gesture by ending the video imaging by the camera upon receiving, from the robot, a notification indicating that the gesture is ended.

6. The imaging system according to claim 5, comprising:
the robot, wherein
upon ending of the gesture, the robot sends the notification indicating that the gesture is ended.

7. The imaging system according to claim 2, wherein
the at least one processor
determines, based on a video obtained by the video imaging, whether the robot has ended the gesture, and
ends the video imaging at the timing corresponding to the timing at which the robot ends the gesture by, upon making a determination that the robot has ended the gesture, ending the video imaging.

8. The imaging system according to claim 1, wherein
the at least one processor
upon the gesture that the robot is to be caused to execute being selected from among the plurality of gestures registered in advance, controls the video imaging by the camera by sending a signal instructing a start of the video imaging to the camera in conjunction with a start of the gesture by the robot.

9. The imaging system according to claim 8, wherein the camera starts the video imaging upon receiving of the signal instructing the start of the video imaging.

10. The imaging system according to claim 8, wherein
the at least one processor
upon the robot ending the gesture, sends, to the camera, a notification indicating that the gesture has ended.

11. The imaging system according to claim 10, wherein the camera ends the video imaging upon receiving of the notification indicating that the gesture has ended.

12. The imaging system according to claim 1, wherein
the robot has set at least one of a personality parameter expressing a pseudo-personality or a growth parameter expressing pseudo-growth, and
the gesture that the robot is to be caused to execute changes in accordance with at least one of the personality parameter or the growth parameter.

13. The imaging system according to claim 1, wherein
the robot includes
a housing in which a head is coupled to a torso by a coupler, and
an exterior covering the torso.

14. An imaging method, comprising:
selecting, from among a plurality of gestures registered in advance, a gesture that a robot is to be caused to execute at a time of video imaging;
starting the video imaging by a camera with the robot as a subject, in conjunction with a start of execution by the robot of the selected gesture; and
ending the video imaging at a timing corresponding to a timing at which the robot ends the gesture.

15. A non-transitory storage medium storing a program readable by a computer of an imaging system, the program causing the computer to realize:
a function of selecting, from among a plurality of gestures registered in advance, a gesture that a robot is to be caused to execute at a time of video imaging;
a function of starting the video imaging by a camera with the robot as a subject, in conjunction with a start of execution by the robot of the selected gesture; and
a function of ending the video imaging at a timing corresponding to a timing at which the robot ends the gesture.
